(19) United States
(12) Patent Application Publication
(10) Pub. No.: US 2025/0051936 A1
(43) Pub. Date: Feb. 13, 2025

(54) ELECTROLYTIC BIOCIDE-GENERATING DEVICE

(71) Applicant: ElectroSea, LLC, Plymouth, MN (US)

(72) Inventors: Louis Ciro Cosentino, Palm Beach Gardens, FL (US); Daniel L. Cosentino, Wayzata, MN (US); Brian Alan Golden, Eden Prairie, MN (US); Peter Samuel Broen Finzell, Shoreview, MN (US)

(21) Appl. No.: 18/798,548

(22) Filed: Aug. 8, 2024

Related U.S. Application Data
(60) Provisional application No. 63/518,420, filed on Aug. 9, 2023.

(51) Int. Cl. C25B 9/65; C25B 9/63; C25B 9/67; C25B 15/02

(52) U.S. Cl. CPC C25B 9/65; C25B 9/63; C25B 9/67; C25B 15/02

(57) ABSTRACT

A biocide-generating device including a housing defining an inlet and an outlet for allowing water to be passed-through the housing; and an electrode arrangement for generating a biocide in the water that passes through the housing. The housing includes a canister having an open end and a closed end, with the canister defining the inlet and the outlet. The housing also includes a removable cover for covering the open end of the canister. Various components of the housing can have a molded plastic construction with reinforcement to improve strength and durability. A circuit arrangement for controlling operation of the electrode arrangement can be housed within a circuitry housing that removably mounts on the cover of the housing.

### CROSS-REFERENCE TO RELATED APPLICATION(S)

This application claims the benefit of U.S. Provisional Application Ser. No. 63/518,420, filed Aug. 9, 2023, the disclosure of which is hereby incorporated by reference in its entirety.

### BACKGROUND

Biological growth can result in the clogging of water systems, and the inefficient operation, overheating, and malfunction of equipment dependent upon the water systems thereby leading to costly downtime and expensive repair. For some applications, the issue of biological growth within water systems is addressed by periodic cleaning of the water systems. Cleaning is expensive, time consuming, and often involves the use of harsh and hazardous chemicals. Improvements in this area are needed.

### SUMMARY

One aspect of the present disclosure relates to a biocide-generating device including a housing defining a chamber. The housing has a molded plastic construction including plastic material defining a port in fluid communication with the chamber. The plastic material defines a helical thread within the port. A port reinforcing ring is integrated with the housing and surrounds a port axis of the port for reinforcing the plastic material of the housing defining the port. The port reinforcing ring has a metal construction. An electrode arrangement is positioned within the chamber for generating biocide within the chamber.

Another aspect of the present disclosure relates to a biocide-generating device including a housing which defines a chamber and has a molded plastic construction. The housing includes a canister body having an open end and a closed end. The canister body has inlet and outlet ports in fluid communication with the chamber. The housing also includes a cover plate assembly adapted to be removably secured to the open end of the canister body to close the open end of the canister body. The cover plate assembly includes a molded plastic cover that is secured to the open end of the canister body by a molded plastic retention ring that is fastened to the canister body to capture the molded plastic cover within a recess defined at the open end of the canister body. The recess is defined by an annular shoulder that supports a sealing ring that is captured and compressed between the molded plastic cover and the annular shoulder. A reinforcing ring is molded within the molded plastic retention ring. The reinforcing ring has a metal construction and is positioned to coincide with an outer circumferential portion of the molded plastic cover when the cover assembly is installed on the canister body. The outer circumferential portion of the molded plastic cover includes a portion of the molded plastic cover that compresses the sealing ring against the annular shoulder of the canister body. The biocide-generating device also includes an electrode arrangement positioned within the chamber for generating biocide within the chamber.

A further aspect of the present disclosure relates to a biocide-generating device including a molded plastic housing defining a chamber. The housing includes a canister body having an open end and a closed end. The canister body includes inlet and outlet ports in fluid communication with the chamber. The housing also includes a cover plate assembly adapted to be removably secured to the open end of the canister body to close the open end of the canister body. The cover plate assembly includes a molded plastic cover that is secured to the open end of the canister body by a molded plastic retention ring that is fastened to the canister body to capture the molded plastic cover within a recess defined at the open end of the canister body. The molded plastic retention ring defines fastener openings. The plastic retention ring is secured to the canister body by threaded fasteners that extend through the fastener openings and thread within internally threaded reinforcing inserts molded within the canister body. The internally threaded reinforcing inserts have a metal construction and include at least two outer annular ribs separated by an annular gap into which plastic material of the canister body flows during molding to provide enhanced retention of the internally threaded reinforcing inserts within the canister body. The biocide-generating device also includes an electrode arrangement positioned within the chamber for generating biocide within the chamber.

Another aspect of the present disclosure relates to a biocide-generating device including a housing defining a chamber. The housing includes a canister body having an open end and a closed end. The canister body has inlet and outlet ports in fluid communication with the chamber. The housing also includes a canister cover adapted to be removably secured to the open end of the canister body to close the open end of the canister body. The biocide-generating also includes an electrode arrangement including first and second electrodes positioned within the chamber for generating biocide within the chamber; a circuitry housing that removably mounts at a top of the canister cover, the circuitry housing being installable on and removable from the canister cover while an interior of the circuitry housing remains enclosed; and a power cord that extends into the circuitry housing for providing electric power to the electrode arrangement. The biocide-generating device further includes a circuit arrangement housed within the circuitry housing. The circuit arrangement includes a power conversion circuit for providing power conversion to the electric power provided to the electrode arrangement from the power cord and also includes switching circuitry for switching a polarity of the first and second electrodes.

A variety of additional inventive aspects will be set forth in the description that follows. The inventive aspects can relate to individual features and to combinations of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 illustrates a watercraft including an on-board water system incorporating a biocide-generating device in accordance with the principles of this disclosure.

FIG. 2 is a perspective view depicting a biocide-generating device in accordance with an embodiment of the disclosure usable in the system of FIG. 1.

FIG. 3 is an exploded, perspective view depicting the biocide-generating device of FIG. 2.

FIG. 4 is an exploded, perspective view depicting a canister body of the biocide-generating device of FIG. 3.

FIG. 5 is a cross-sectional view depicting the canister body of FIG. 4.

FIG. 6 is an enlarged, exploded, cross-sectional view depicting a portion of the canister body of FIG. 5.

FIG. 7 is a cross-sectional view cut through the inlet and outlet of the biocide-generating device of FIG. 2.

FIG. 8 is an enlarged cross-sectional view depicting a portion of the biocide-generating device of FIG. 7.

FIG. 9A is a cross-sectional view depicting a retention ring of the biocide-generating device of FIG. 2.

FIG. 9B is a cross-sectional view depicting a reinforcing ring adapted to reinforce the retention ring of FIG. 9A.

FIG. 10 is a cross-sectional view through an upper portion of the biocide-generating device of FIG. 2.

FIG. 11 is a perspective view depicting a fastener and internally threaded insert of the biocide-generating device of FIG. 2.

FIG. 12 is an exploded view depicting another biocide-generating device in accordance with the principles of the present disclosure.

FIG. 13 is a schematic diagram of a circuit arrangement of the biocide-generating device of FIG. 12.

FIG. 14 is a perspective view of the biocide-generating device of FIG. 12.

FIG. 15 is a top view of the biocide-generating device of FIG. 14.

FIG. 16 is an inlet side view of the biocide-generating device of FIG. 14.

FIG. 17 is a partially exploded view of the biocide-generating device of FIG. 14.

FIG. 18 depicts the biocide-generating device of FIG. 14 with a control assembly of the biocide-generating device removed from a canister cover of a main housing of the biocide-generating device.

FIG. 19 is a cross-sectional view of the biocide-generating device of FIG. 14 taken along section line 19-19 of FIG. 15.

FIG. 20 is a cross-sectional view of the biocide-generating device of FIG. 14 taken along section line 20-20 of FIG. 15.

FIG. 21 is a cross-sectional view of the circuitry housing of the biocide-generating device of FIG. 14 with the circuit arrangement removed.

FIG. 22 depicts the circuitry housing of FIG. 21 with a top dome removed to expose a circuit board supporting a circuit arrangement of the biocide-generating device of FIG. 14.

FIG. 23 depicts the arrangement of FIG. 22 with the circuit board removed.

FIG. 24 is a top, perspective view of the lower base of the circuitry housing of the biocide-generating device of FIG. 14.

FIG. 25 is a perspective view of a heat sink that mounts within the circuitry housing of the biocide-generating device of FIG. 14.

FIG. 26 schematically depicts example heat flow paths for the biocide-generating device of FIG. 14.

FIG. 27 depicts another control assembly in accordance with the principles of the present disclosure shown with a corresponding canister cover and electrode arrangement.

FIG. 28 is an exploded view of the control assembly of FIG. 27 shown isolated from the canister cover and the electrode arrangement.

FIG. 29 is another exploded view of the control assembly of FIG. 27.

FIG. 30 is a cross-sectional view of the control assembly of FIG. 27 mounted to the canister cover.

FIG. 31 is an enlarged view of a portion of FIG. 30.

### DETAILED DESCRIPTION

The present disclosure relates to biocide-generating devices and systems for the treatment of water systems. Examples of biocides include chlorine and derivatives thereof, copper, and other biocides. Certain aspects of the present disclosure relate to features to enhance the robustness and longevity of structural components comprising the biocide-generating devices and systems. Reference will now be made in detail to exemplary aspects of the present disclosure that are illustrated in the accompanying drawings. Wherever possible, the same reference numbers will be used throughout the drawings to refer to the same or like parts.

One aspect of the present disclosure relates to a biocide-generating device including a composite housing defining an electrolytic cell chamber. As compared to an all metal housing, the composite housing can have a reduced weight and cost. In one example, the composite housing includes one or more reinforcing inserts at least partially embedded with respect to one or more molded plastic parts (e.g., injection molded plastic parts) of the composite housing. Example materials for the molded plastic parts can have material compositions that include plastic materials such as polypropylene, polyamide, polycarbonate or other plastic materials. The reinforcing inserts can be constructed of a material (e.g., a metal material such as a metal alloy such as stainless steel or a metal element such as titanium) having higher strength than the molded plastic material of the molded parts. In one example, the composite housing can include a molded canister body and cover plate assembly, the molded canister body having an open end and opposite closed end, the cover plate assembly being adapted to be removably secured to the open end of the canister body to close the open end of the canister body. The cover plate assembly is selectively removable from the canister body for servicing of the biocide-generating device. In certain embodiments, the one or more reinforcing inserts can be configured for reinforcing internally threaded ports (e.g., an inlet port, an outlet port, a re-circulation port, a drain port) defined by the molded canister body that are in communication with an electrolytic cell chamber. In one example, the internally threaded ports are defined in part within a molded main wall of the canister body and in part within molded exterior port projections that project from the molded main wall of the canister body, and the port reinforcing inserts are configured as reinforcing rings (e.g., caps) that mount over and around the port projections. The port reinforcing inserts can extend around the exterior of the port projections to provide the molded port projections with increased hoop strength. In certain examples, during insert molding, the molded plastic of the port projections flows into interior features (e.g., openings, notches, slots, etc.) of the port reinforcing inserts to integrate and retain the reinforcing inserts with respect to the canister body. In certain examples, the cover assembly can include a molded plastic cover that is secured to the open end of the canister body by a molded plastic retention ring that is fastened to the canister body to capture the molded plastic cover within a recess defined at the open end of the canister body. The recess can be defined by an annular shoulder that supports a sealing ring that is captured and compressed between the cover and the annular shoulder. A reinforcing insert such as a reinforcing ring can be molded within the plastic retention ring. The reinforcing ring can have a metal construction and can be positioned to align with an outer circumferential portion of the cover when the cover assembly is installed on the canister. The outer circumferential portion of the cover includes a portion of the cover that compresses the sealing ring against the annular shoulder of the canister. In one example, the reinforcing ring can overlap an outer circumferential edge of the plastic cover. In one example, the reinforcing ring can have an inner diameter smaller than an outer diameter of the cover and an outer diameter larger than the outer diameter of the cover. In one example, the inner diameter of the reinforcing ring can be sized between an inner diameter of the sealing ring and/or the annular shoulder and an outer diameter of the sealing ring and/or the annular shoulder. In one example, the outer diameter of the reinforcing ring can be sized larger than the outer diameter of the sealing ring and/or the annular shoulder. In certain examples, the plastic retention ring includes plastic cars that align with plastic cars defined by the molded plastic canister. The cars of the plastic retention ring can be secured to the cars of the canister by threaded fasteners that thread within internally threaded reinforcing inserts molded within the cars of the plastic canister. The internally threaded reinforcing inserts can have a metal construction (e.g., stainless steel, titanium, etc.) and can include at least one and preferably two outer annular ribs separated by an annular gap into which plastic material of the cars of the canister flows during molding to provide enhanced retention of the internally threaded reinforcing inserts within the cars of the canister. Outer circumferential surfaces of the annular ribs can be knurled.

The present disclosure relates to biocide-generating devices and systems for inhibiting biofouling within a water system. Example biocides can include chlorine and derivatives thereof, copper, and other biocides. Example biocide-generating devices can include electrolytic cells including electrodes adapted to generate biocides such as chlorine and derivatives thereof when electrical current flows across the electrodes. In certain examples, the biocide-generating devices or systems introduce biocide into the water flowing through the water systems in-situ (e.g., in real time during operation of the water systems). Preferably, the biocide is introduced at a concentration high enough to prevent the growth of biomass within the components of the water system. Example water system components through which the biocide treated water flows can include heat exchangers for air conditioners and chillers.

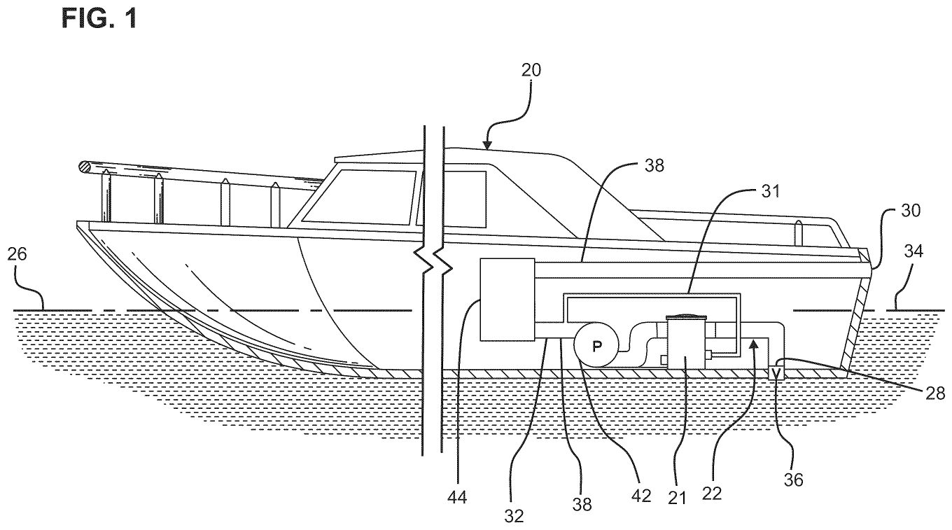

FIG. 1 illustrates a watercraft 20 having an on-board water system 22 including a biocide-generating device 21 in accordance with the principles of the present disclosure. The watercraft 20 is shown supported on a body of water 26. The on-board water system 22 includes an inlet 28, an outlet 30, and a water flow path 32 that extends from the inlet 28 through the watercraft 20 to the outlet 30. The inlet 28 is configured for drawing water from the body of water 26 into the water flow path 32. The inlet 28 is located below a water line 34 of the watercraft 20 and is preferably located at a bottom of the hull of the watercraft 20. The inlet 28 can be opened and closed by a valve 36 such as a seacock. The outlet 30 is configured for discharging water that has passed through the water flow path 32 back to the body of water 26. Preferably, the outlet 30 is positioned above the water line 34. The on-board water system 22 can include a plurality of components positioned along the water flow path 32. The water flow path 32 can include a plurality of conduits 38 (e.g., hoses, tubes, pipes, etc.) which extend between the components of the on-board water system 22 and function to carry water along the water flow path 32 between the various components. As shown at FIG. 1, the depicted components include the biocide-generating device 21 (which can include an integrated strainer), a pump 42, and one or more systems and/or equipment 44 that make use of water conveyed through the water flow path 32. The biocide-generating device 21 is adapted for generating a biocide within the water of the water flow path 32 while the water passes through the biocide-generating device 21. The biocide is configured for inhibiting biofouling within the conduits 38 and within one or more of the components positioned along the water flow path 32. A recirculation line 31 can re-circulate treated water from a location downstream of the pump 42 back to the biocide-generating device 21. It will be appreciated that the biocide can also be referred to as a disinfecting agent or a cleaning agent since the biocide can also include disinfecting and cleaning properties.

It will be appreciated that examples of the type of the systems and/or equipment 44 that can benefit from biocide treatment can include cooling systems such as air conditioners or chillers where water drawn from the body of water 26 can be used as a cooling media for cooling refrigerant of the cooling systems. In other examples, the water from the water flow path 32 can be used to provide engine cooling. In other examples, water from the water flow path 32 can be used for sanitation systems or watercraft propulsion systems.

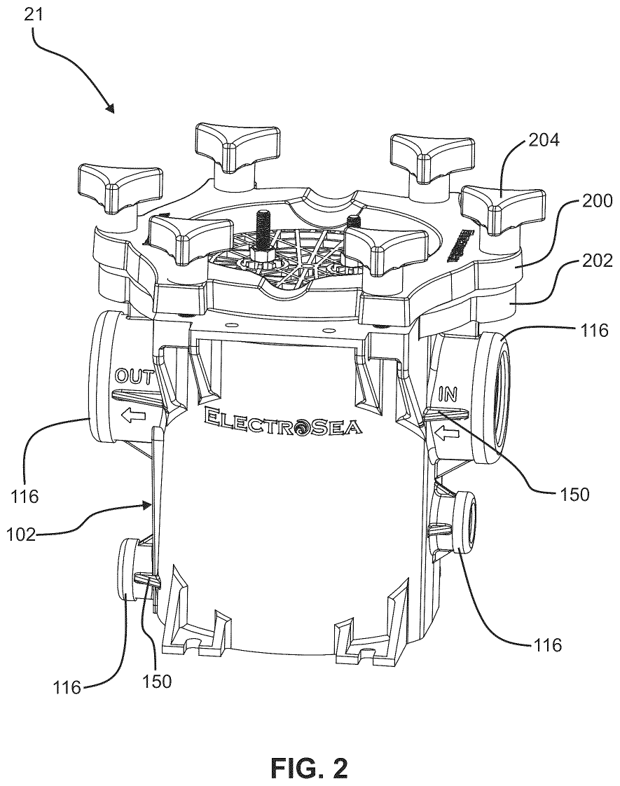

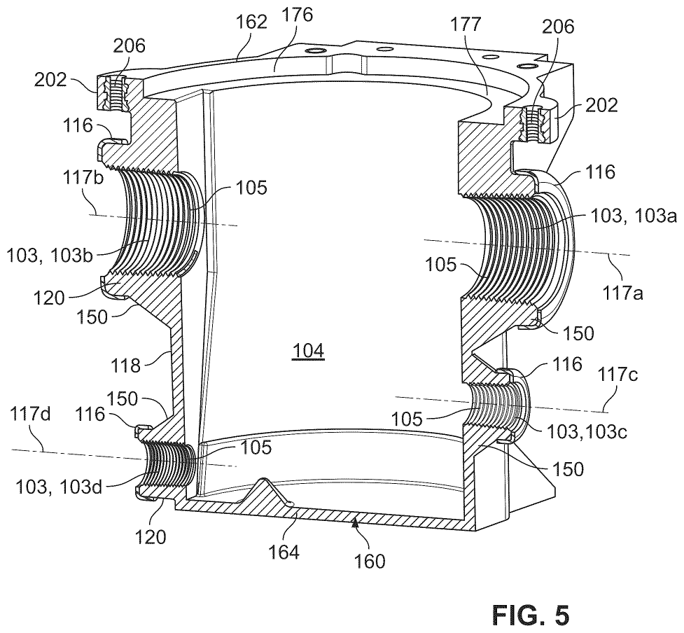

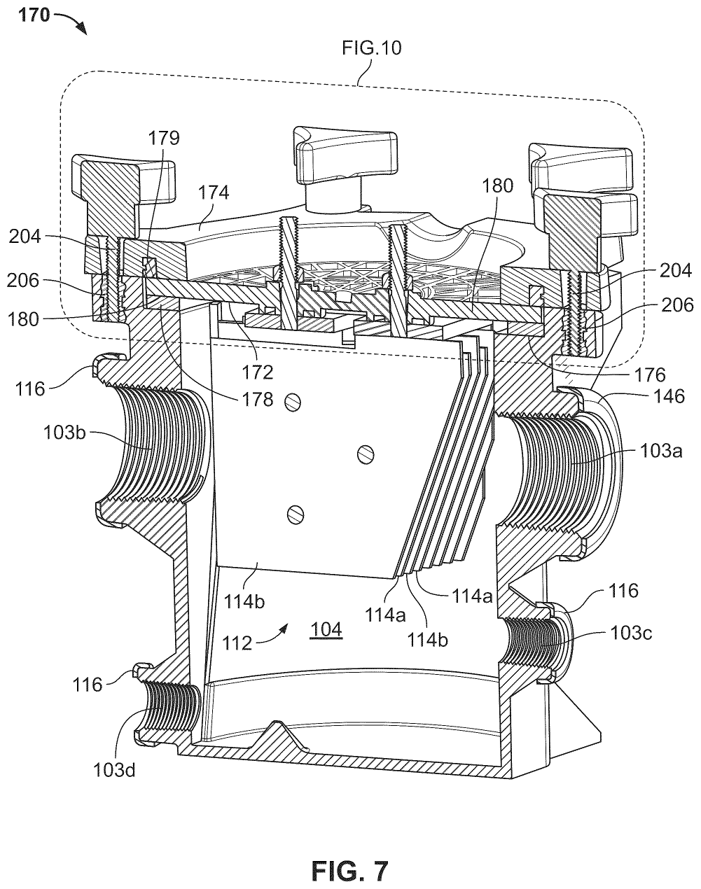

FIG. 2 depicts an example configuration in accordance with the principles of the present disclosure for the biocide-generating device 21. The biocide-generating device 21 includes a housing 102 defining a chamber 104 (see FIG. 5). In a preferred example, the housing 102 has a molded plastic construction including plastic material defining a plurality of ports 103 in fluid communication with the chamber 104. In certain example, the plastic material can have a composition that includes materials such as polypropylene, polyamide and polycarbonate. The plastic material can include a composition that includes individual compounds, combinations of compounds and additives. In the depicted example, the housing 102 defines an inlet port 103a for directing water from the water flow path 32 into the chamber 104 and an outlet port 103b for discharging water treated with biocide from the chamber to a downstream portion of the water system 32. The housing 102 can also define a re-circulation port 103c and a drain port 103d in fluid communication with the chamber 104. The re-circulation port 103c can connect to the recirculation line 31. The biocide-generating device 21 also includes an electrode arrangement 112 positioned within the chamber 104 (see FIG. 7) for generating biocide within the water flowing through the chamber 104 for treating the water system 32. For example, the biocide-generating device 21 can generate biocides such as chlorine and derivatives thereof within the water flowing through the chamber 104 when electrical current flows across the electrodes. The electrode arrangement 112 can include a first electrode including a first set of electrode members such as electrode plates 114a and a second electrode including a second set of electrode members such as electrode plates 114b that are preferably interleaved with respect to each other when installed in the housing 102. During biocide generation, one of the sets of plates 114a, 114b functions as an anode and the other of the sets of plates 114a, 114b functions as a cathode. Preferably, the polarity of the sets of plates 114a, 114b shifts in an alternating manner to reduce sealing. An example switching configuration for switching the polarity of the sets of plates 114a, 114b such that the system alternates between one state in which the plates 114a function as an anode and the plates 114b function as a cathode and another state in which the plates 114a function as a cathode and the plates 114b function as an anode is disclosed at PCT International Publication No. WO2019/070877, which is hereby incorporated by reference in its entirety. In certain examples, a strainer can also be incorporated within the housing 102 of the biocide-generating device 21.

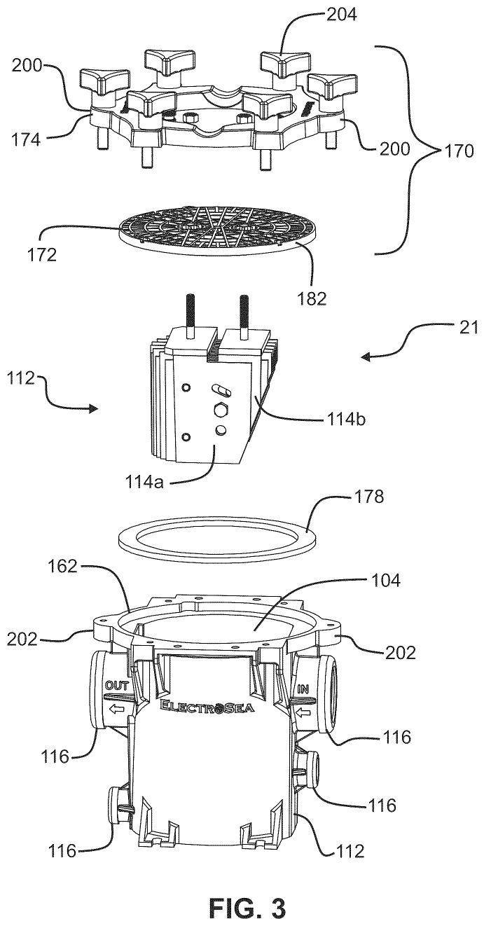

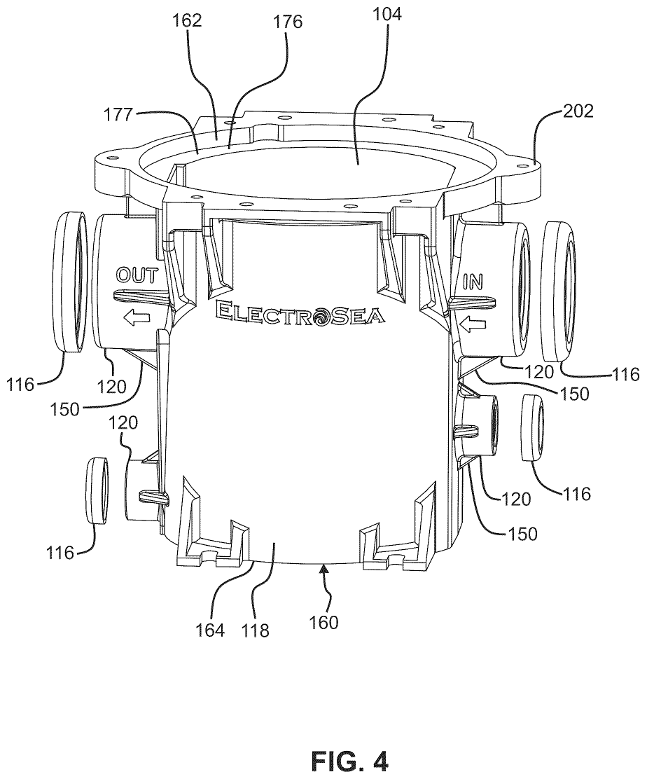

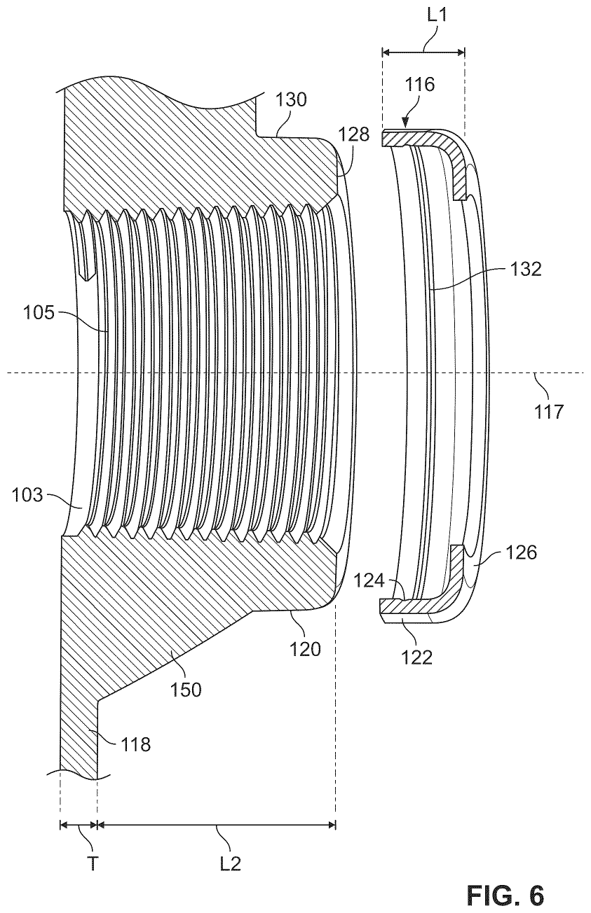

In the depicted example of FIGS. 2-5, the plastic material of the housing 102 defining the ports 103 defines helical threads 105 within the ports 103. Additionally, port reinforcing rings 116 are integrated with the housing 102 and surround a port axis 117 (see FIG. 6) of each port 103 for reinforcing the plastic material of the housing 102 defining the port 103. Individual port axes 117a-117d are depicted for each of the ports 103a-103d. The port reinforcing rings 116 each have a metal construction. As shown at FIG. 4, the housing 102 includes a sidewall 118 and port projections 120 that project from an exterior of the sidewall 118 at each of the ports 103. Each port 103 extends through the sidewall 118 and a corresponding one of the port projections 120. The port reinforcing rings 116 are constructed as caps secured on the port projections 120. As shown at FIG. 6, the caps include circumferential portions 122 having inner surfaces 124 facing radially toward the axes 117a-117d of the ports 103a-103d and flange portions 126 that project radially inwardly from the circumferential portions 122 and oppose axial ends 128 of the port projections 120.

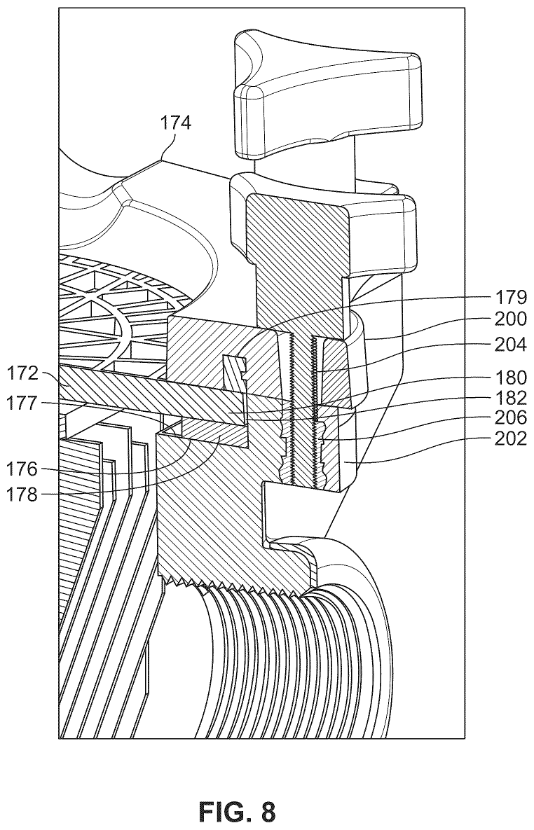

As depicted at FIGS. 6-8, the flange portions 126 are oriented perpendicularly relative to the axes 117 of the ports 103. The inner surfaces 124 of the circumferential portions 122 of the caps oppose outer circumferential surfaces 130 of the port projections 120. The inner surfaces 124 of the circumferential portions 122 each define an interlock structure such as at least one recess 132 into which plastic material of the port projections 103 are molded to provide retention of the caps on the port projections 103. Alternatively, the caps can include interlock structures such as projections/protrusions over which the plastic material of the port projections 103 are molded such that the projections/protrusions embed in the plastic material to provide enhanced retention. The caps provide enhanced hoop strength to the port projections 103 which assists in preventing deformation and/or cracking when fittings are threaded in the ports 103. In certain examples, the recesses 132 define channels into which portions of liquid plastic material of the housing 102 can flow and cure/solidify during molding/formation of the port projections 120 of the housing 102 for improved adherence of the caps to the plastic material forming the port projection 120. In certain examples, the recesses 132 are circumferential grooves.

Referring to FIGS. 2, 5 and 6, the housing 102 includes gussets 150 integrally (e.g., unitarily) molded with the outer circumferential surfaces 130 of the port projections 120 and also integrally (e.g., unitarily) molded with the sidewall 118 of the housing 102 for reinforcing the port projections 120 relative to the sidewall 118 of the housing 102. In certain examples, the caps have axial lengths L1 (see FIG. 6) that extend from the outer ends of the port projections 120 to the gussets 150. In certain examples, the port projections 120 have axial lengths L2 (see FIG. 6) that are at least two times as long as a nominal thickness T (see FIG. 6) of the sidewall 118.

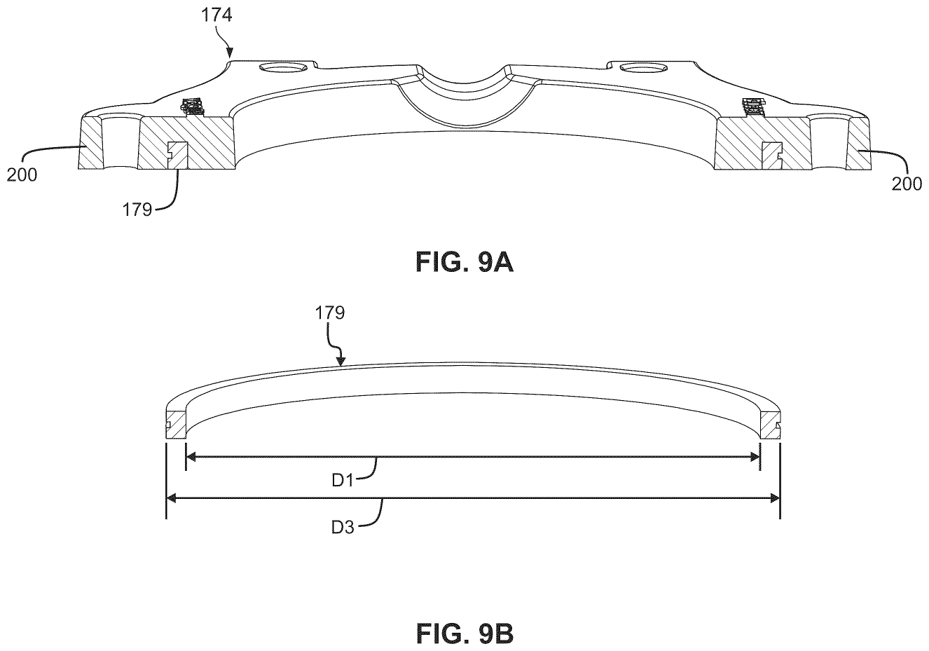

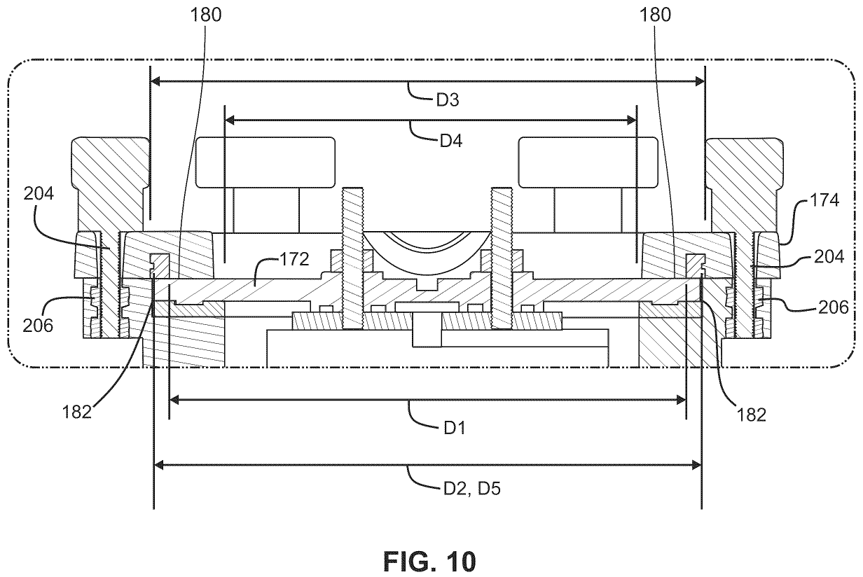

Referring to FIGS. 4 and 5, the housing 102 includes a canister body 160 having an open end 162 and a closed end 164. The canister body 160 includes the side wall 118 and the ports 103 are defined though side wall 118. The side wall 118 extends between the open end 162 and the closed end 164. The housing 102 also includes a cover plate assembly 170 (sec FIGS. 2, 3 and 7) adapted to be removably secured to the open end 162 of the canister body 160 to close the open end 162 of the canister body 160. The cover plate assembly 170 can include a molded plastic cover 172 that is secured to the open end 162 of the canister body 160 by a molded plastic retention ring 174 that is fastened to the canister body 160 to capture the molded plastic cover 172 within a recess 176 defined at the open end 162 of the canister body 160. The recess 176 is defined by an annular shoulder 177 that supports a sealing ring 178 that is captured and compressed between the molded plastic cover 172 and the annular shoulder 177. A reinforcing ring 179 (see FIGS. 7-10) is molded within the molded plastic retention ring 174. The reinforcing ring 179 has a metal construction and is positioned to coincide with (e.g., be positioned over) an outer circumferential portion 180 of the molded plastic cover 172 when the cover plate assembly 170 is installed on the canister body 160. The outer circumferential portion 180 of the molded plastic cover 172 includes a portion of the molded plastic cover 172 positioned to compresses the sealing ring 178 against the annular shoulder 177 of the canister body 160. The reinforcing ring 179 can include a circumferential notch at an outer diameter of the reinforcing ring 179. The notch can be filled with plastic material from the molded plastic retention ring 174 during molding of the molded plastic retention ring 174 over the reinforcing ring 179 to enhance retention of the reinforcing ring 179 within the molded plastic retention ring 174. The molded plastic cover 172 can include a rib 199 (e.g., an annular projection) that is concentric with a center of the cover 172 and that presses into the sealing ring 178 when the cover 172 is secured to the cannister body 160 to enhance sealing. The reinforcing ring 179 can be configured to reduce deformation of the molded plastic retention ring 179 and to ensure adequate and preferably uniform compression of the sealing ring 178 around the entire circumference of the sealing ring 178.

The reinforcing ring 179 is configured to overlap an outer circumferential edge 182 of the molded plastic cover 172 when the cover plate assembly 170 is installed on the canister body 160. The reinforcing ring 179 has an inner diameter D1 smaller than an outer diameter D2 of the molded plastic cover 172 and an outer diameter D3 larger than the outer diameter D2 of the molded plastic cover 172. The inner diameter D1 of the reinforcing ring 179 is sized between an inner diameter D4 of the sealing ring and/or the annular shoulder and an outer diameter D5 of the sealing ring and/or the annular shoulder. The outer diameter D3 of the reinforcing ring 179 is sized larger than the outer diameter D5 of the sealing ring and/or the annular shoulder. In certain examples, the reinforcing ring 179 is positioned to be over at least a portion of the sealing ring 178 when the housing is assembled. In certain examples, the reinforcing ring 179 is positioned to be over at least a portion of an outermost 30, 25, 20, or 15 percent of the radius of the cover 172 when the housing is assembled.

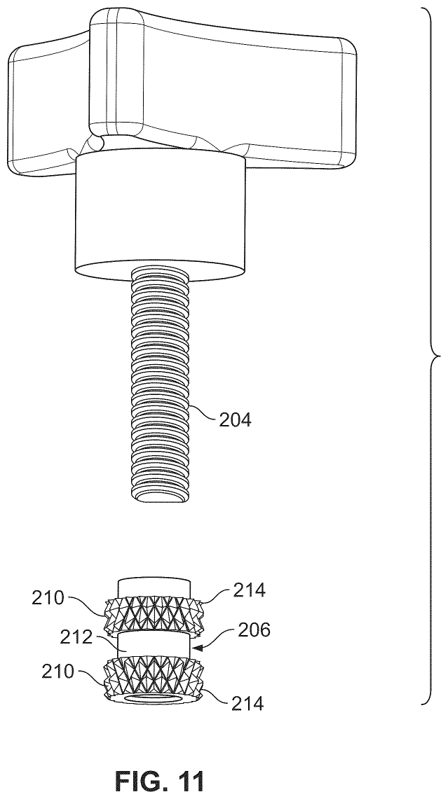

The molded plastic retention ring 174 includes a flange including plastic cars 200 that align with plastic cars 202 defined by the canister body 160. The plastic ears 200 of the plastic retention ring 174 are secured to the cars 202 of the canister body 160 by threaded fasteners 204 that thread within internally threaded reinforcing inserts 206 (see FIGS. 7 and 11) molded within the cars 202 of the canister body 160. The internally threaded reinforcing inserts 206 have a metal construction and include at least two outer annular ribs 210 separated by an annular gap 212 into which plastic material of the cars 202 of the canister body 160 flows during molding to provide enhanced retention of the internally threaded reinforcing inserts 206 within the cars 202 of the canister body 160. As depicted, outer circumferential surfaces 214 of the annular ribs 210 are knurled. The inserts 206 can also be incorporated into the flange of the canister body 206 at regions other than the cars 202.

The electrode arrangement 112 is mounted to (e.g., fastened to) and carried with the cover 172. Access to the electrode arrangement 112 is provided by removal of the cover 172 from the canister body 160, thereby concurrently removing the electrode arrangement 112 carried with the cover 172 from the canister body 160 and enabling the electrode arrangement 112 to be cleaned and/or replaced as needed. Thereafter, the cover plate 172 can be re-secured to the canister body 160 via the retention ring 174 and fasteners 204, with the elastomeric sealing ring 178 providing a fluid tight seal therebetween. Since the electrode arrangement 112 is carried with the cover 172, the electrode arrangement 112 is re-installed in the canister body 160 concurrent with the installation of the cover 172 on the canister body 160.

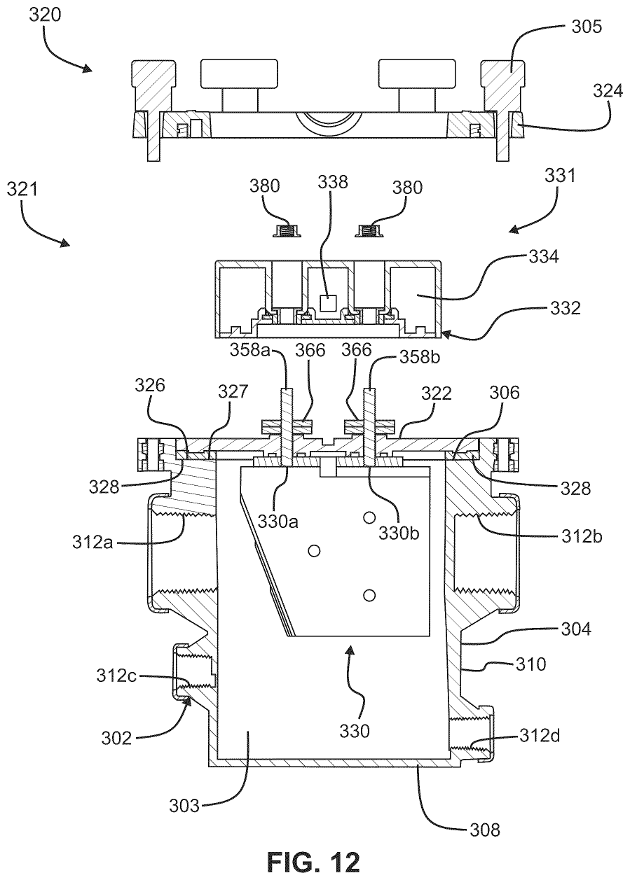

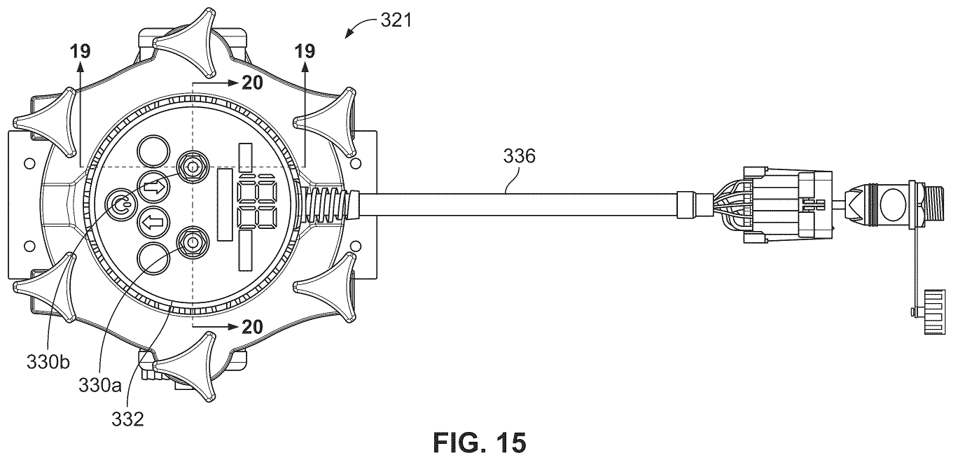

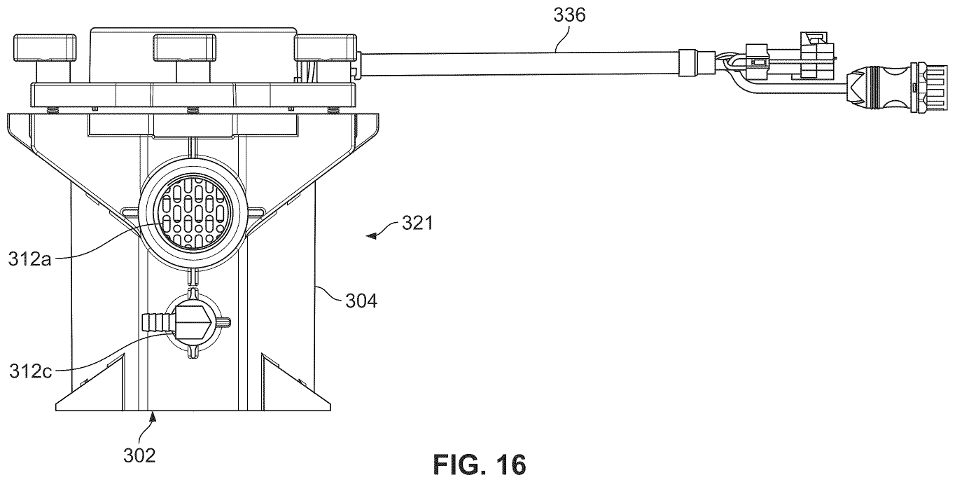

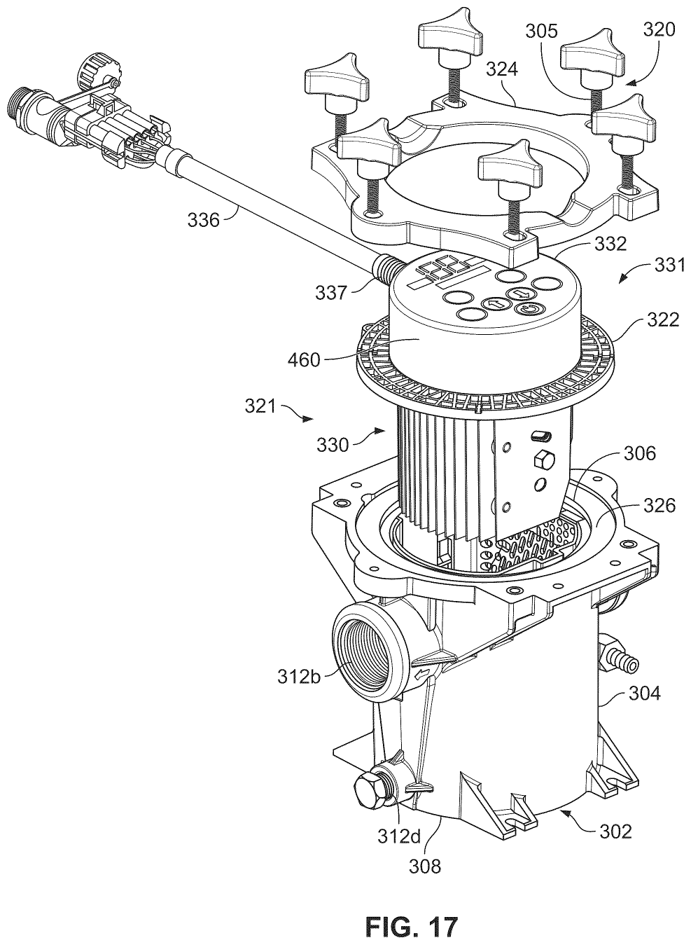

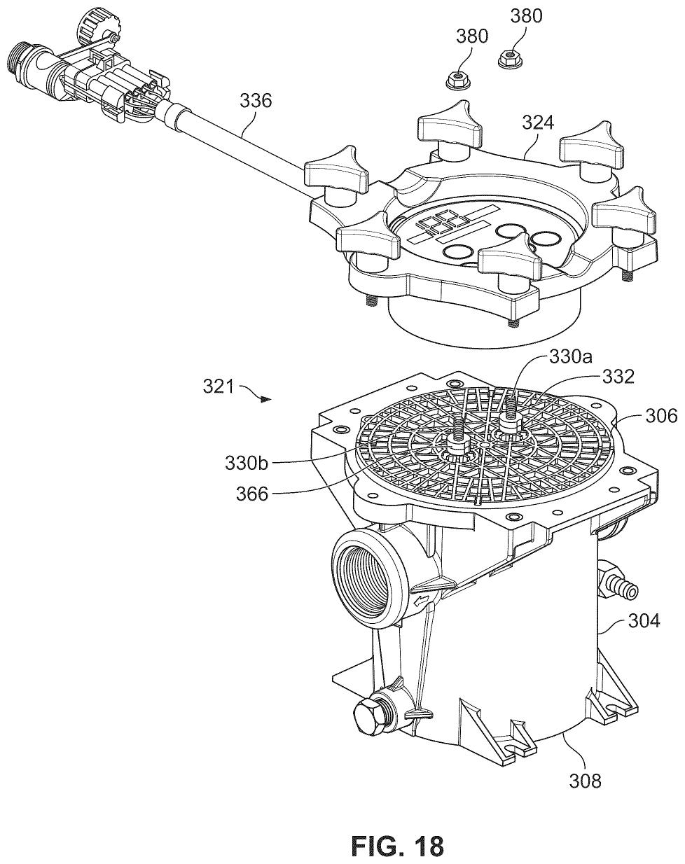

FIGS. 12-26 depict another biocide-generating device 321 in accordance with the principles of the present disclosure. In one example, the biocide generating device 321 includes a main housing 302 that can include a reinforced plastic construction including one or more of the reinforcing features described above. The main housing 302 defines a chamber 303 through which water flows and in which biocide is generated. The main housing 302 includes a canister body 304 that can have a similar or same configuration as the canister body 160. The canister body 304 has an open end 306 and a closed end 308. The canister body 304 includes a side wall 310 that extends between the open and closed ends 306, 308. The canister body 304 defines ports 312 (e.g., a water inlet port 312a for directing water into the chamber 303, a water outlet port 312b for directing water outer of the chamber 303, a recirculation port 312c for recirculating treated water back into the chamber 303 and a drain port 312d for draining water from the chamber 303 during maintenance) though the side wall 310. The main housing 302 also includes a cover assembly 320 (see FIG. 12). The cover assembly 320 can include a canister cover 322 adapted to be removably secured to the open end 306 of the canister body 304 to close the open end 306 of the canister body 304. The canister cover 322 can have a molded, plastic construction. The cover assembly 320 also includes a retention ring 324 that is fastened to the canister body 304 (e.g., via fasteners such as threaded fasteners 305) to secure the canister cover 322 to the canister body 304 over the open end 306 of the canister body 304. In one example, the canister cover 322 seats within a within a recess 326 defined at the open end 306 of the canister body 304. The recess 326 is depicted as being defined by an annular shoulder 327 that supports a sealing ring 328 that is captured and compressed between the canister cover 322 and the annular shoulder 327. In one example, the retention ring 324 can be reinforced in the same way as the retention ring 174.

The biocide-generating device 321 also includes an electrode arrangement 330 including first and second electrodes 330a, 330b positioned within the chamber 303 for generating biocide within the chamber 303. The biocide-generating device 321 also includes a control assembly 331 (e.g., a control module) including a circuitry housing 332 that removably mounts at an exterior of the canister cover 322. The circuitry housing 332 is installable on and removable from the canister cover 322 while an interior 334 of the circuitry housing 332 remains enclosed and environmentally sealed. FIG. 12 shows the circuitry housing 332 detached from the canister cover 322.

The control assembly 331 includes a power cord 336 (i.e., a power cable) that extends into the circuitry housing 332 for providing electric power to the electrode arrangement 330. The circuitry housing 332 can be sealed where the power cord 336 enters the circuitry housing 332 and a boot 337 can be provided for providing strain relief to the power cord 336 at the location where the power cord 336 enters to the circuitry housing 332. The power cord 336 can include one or more electrically conductive wires for carrying power in the form of electricity from an external power source 341 (e.g., a battery, generator or other power source which in some examples can range from about 12 volts to about 240 volts of alternating current (AC) or direct current (DC)) to a circuit arrangement 338 of the control assembly 331 housed within the circuitry housing 332). The power cord 336 can also include one or more communication wires for connecting the circuit arrangement 338 to other components such as sensors (e.g., a water flow sensor 339 for sensing water flow through the biocide-generating device 321 such as at the outlet of the biocide-generating device), a main controller, one or more water pumps, a remote display, a remote controller, and other components.

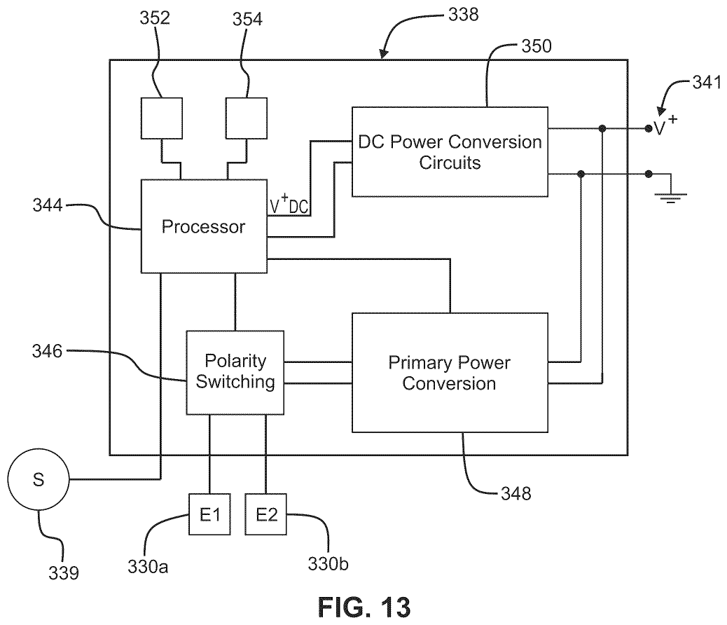

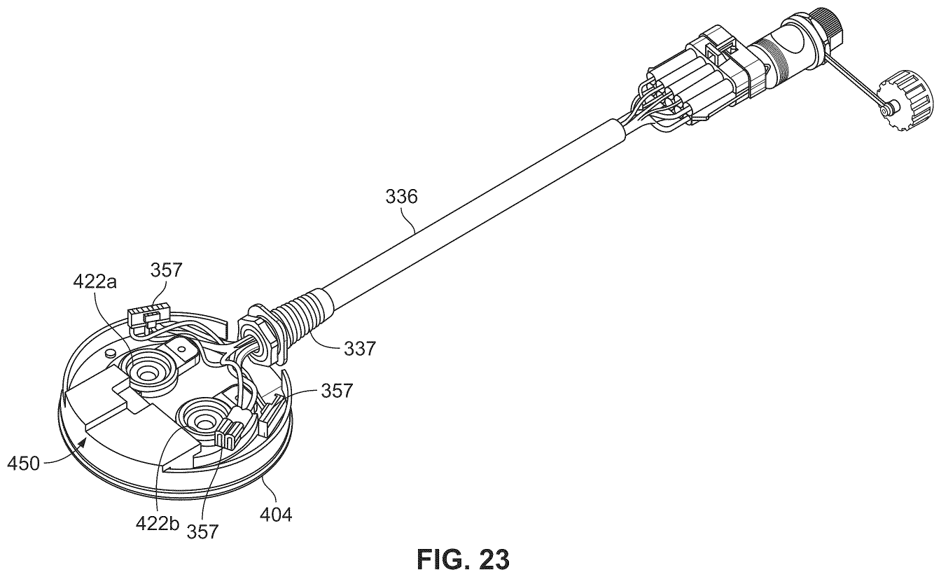

Referring to FIG. 13 the circuit arrangement 338 can include, among other things, an electronic controller 344, a polarity switching arrangement 346, a first power conversion circuit 348, and a second power conversion circuit 350. The first power conversion circuit 348 provides power conversion for reducing the voltage of the supplied power carried to the circuit arrangement 338 by the power cord 336 from the external power source 341 to a voltage level suitable for allowing relatively high levels of current to be applied across the electrode arrangement 330 to facilitate the production of biocide in the water flowing through the biocide-generating device. In a preferred example, the first power conversion circuit 348 provides direct current (DC) to direct current (DC) voltage conversion, but could also provide alternating current (AC)/(DC) conversion in cases where power supplied from the eternal power source is AC power. The second power conversion circuit 350 can provide power conversion for converting power from the external power source 341 to a voltage suitable for use with an electronic processor of the controller 344. The polarity switching arrangement 346 is configured to periodically switch the polarity of the first and second electrodes 330a, 330b during biocide generation to reduce sealing. The circuit arrangement 338 can include isolation circuitry for electrically isolating the electrolysis circuit (e.g., the circuit is isolated from ground of the external power source). To coordinate and implement application of current (e.g., DC current) across the electrodes 330a, 330b during biocide generation, the electronic controller 344 can have one or more processors, which can interface with software, firmware and/or hardware. In some embodiments, the controller 344 can include digital or analog processing capabilities, and can interface with the optional memory (e.g., random access memory, read-only memory, or other data storage). In some embodiments, the controller 344 can include a programmable logic controller, one or more processors, or like structures. The controller 344 can also interface with user interface 352 (e.g., control buttons, switches, etc.) which in some embodiments can include one or more displays 354 (e.g., indicator lights, LEDs, display screen, etc.). In certain examples, the circuit arrangement 338 can function as a constant current power supply for generating a constant DC electrical current across the electrodes 330a, 330b during biocide generation. In certain examples, the electronic controller 344 interfaces with the flow sensor 339 for sensing water flow through the biocide-generating device 321 and varies a magnitude of the constant current based on sensed water flow. In a preferred example, the circuit arrangement 338 is supported by a circuit board 355 housed within the circuitry housing 332. Example circuit arrangements providing a constant current source, voltage conversion, electrical isolation and polarity shifting are disclosed in PCT International Publication No. WO2019/070877, which is hereby incorporated by reference in its entirety. Connectors 357 (see FIG. 23) can be used to connect the circuit board 355 to wires of the power cord 336.

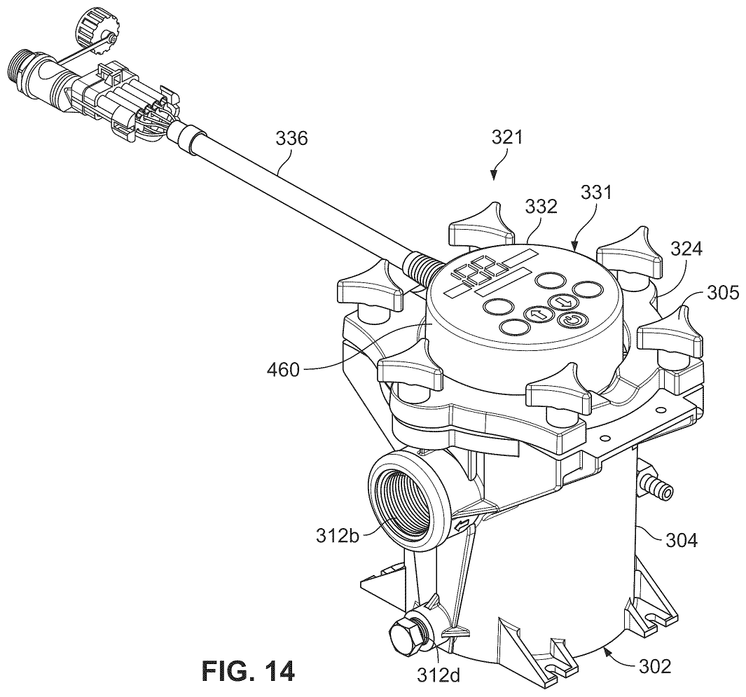

In one example, the display 354 and/or the user interface 352 can be integrated with the circuitry housing 332 (e.g., a top wall of the circuitry housing 332 as shown at FIG. 14). In certain examples, the display 354 on the circuitry housing 332 can interface with the controller to display a real-time rate of water flow through the biocide-generating device 321 as sensed by the water flow sensor 339. In certain examples, the display 354 on the circuitry housing 332 can provide a real-time indication of operational status (system running, system turned-off, error indication, alert indication, low-flow indication, plugged strainer indication, error code, etc.).

In certain examples, the electrode arrangement 330 mounts to the canister cover 322 and is carried with the canister cover 322 when the canister cover 322 is installed on or removed from the canister body 304. In certain examples, when the circuitry housing 332 is removed (e.g., detached) from the canister cover 322, the circuit arrangement 338 concurrently electrically disconnects from the electrode arrangement 330; and when the circuitry housing 332 is coupled (e.g., mechanically fastened) to the canister cover 322, the circuit arrangement 338 concurrently electrically connects with the electrode arrangement 330. In certain examples, terminal posts of the electrode arrangement 330 are configured to interface with fasteners such as threaded fasteners (e.g., nuts) to provide two or more of the following results/functions: a) detachable mechanical securement of the circuitry housing 332 to the canister cover 322; b) disconnectable electrical connection of the electrode arrangement 330 to the circuit arrangement 338; and c) completion of a heat transfer path between a component of the circuit arrangement 338 and the electrode arrangement 330

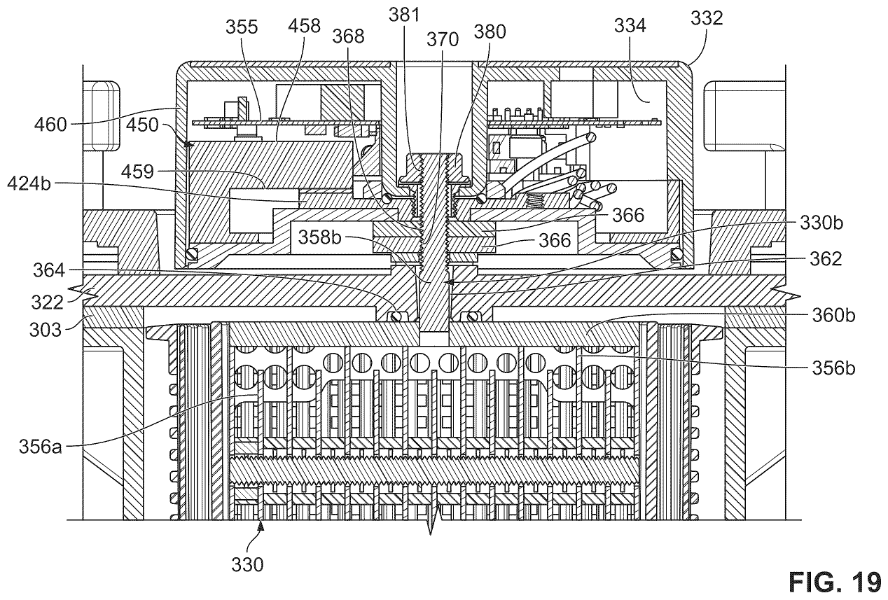

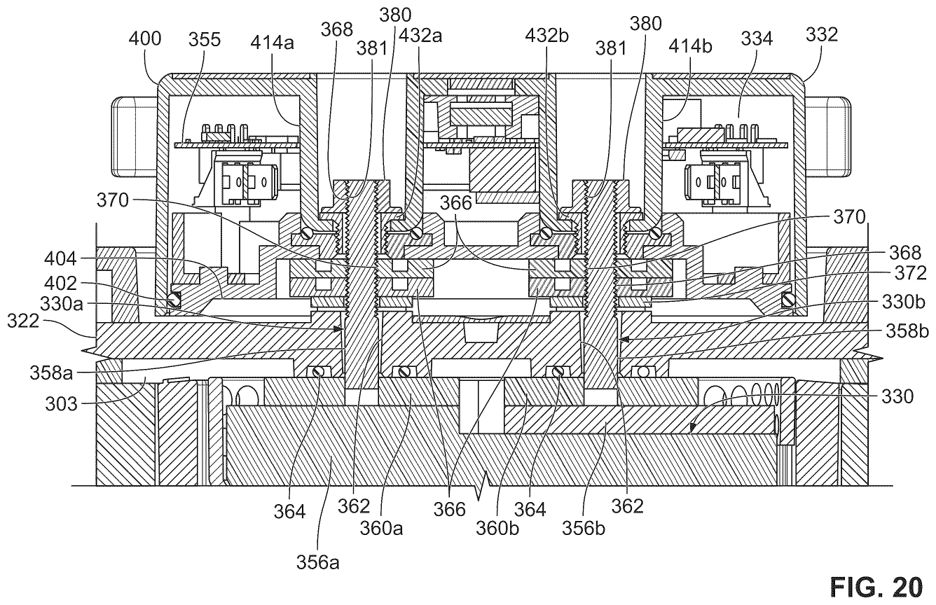

Referring to FIGS. 19 and 20, the first electrode 330a includes a plurality of first electrode plates 356a electrically coupled to a first terminal post 358a through a connection plate 360a; and the second electrode 330b includes a plurality of second electrode plates 356b electrically coupled to a second terminal post 358b by a second connection plate 360b. The component parts of the electrodes 330a, 330b can each be configured to resist corrosion and to conduct both electricity and heat. In one example, the components of the electrodes 330a, 330b are made of a material having a composition that includes metal (e.g., a metal element such as titanium or a metal alloy material such as stainless steel). The first and second terminal posts 358a, 358b extend through the canister cover 322 (e.g., through cover openings 362 in the canister cover 322). Seals 364 (e.g., sealing members which may include elastomeric gaskets such as o-rings) concentrically surround the openings 362 and the terminal posts 358a, 358b and provide sealing between an interior side of the canister cover 322 and upper sides of the connection plates 360a, 360b to prevent water from the chamber 303 from leaking through the openings 362. Electrode fasteners 366 are secured to the first and second terminal posts 358a, 358b to mount the electrode arrangement 330 to the canister cover 322. As depicted, a threaded engagement is provided between the electrode fasteners 366 and the first and second terminal posts 358a, 358b. For example, the first and second terminal post 358a, 358b are depicted having external threads 368 that engage with internal threads 370 of the electrode fasteners 366. By threading the electrode fasteners 366 on the first and second terminal posts 358a, 358b, the canister cover 322 can be clamped between the electrode fasteners 366 and the connection plates 360a, 360b thereby securing the electrode arrangement 330 to the canister cover 322 and compressing the seals 364 between the interior side of the canister cover 322 and the top side of the connection plates 360a, 360b. As depicted, two of the electrode fasteners 366 and a washer 372 are secured to each of the first and second terminal posts 358a, 358b. As depicted, the fasteners 366 are shaped as disc-shaped nuts having features (e.g., notches) present in top sides of the fasteners 366 adapted for engaging a torque transfer tool such as a keyed-wrench. By pairing the fasteners 366 on each of the terminal posts 358a, 358b, the paired fasteners 366 work against one another the resist untightening. The fasteners 366 provide a securement function for securing the electrode arrangement 330 to the canister cover 322 and also provide a spacing/support function for engaging and supporting a bottom side of the circuitry housing 332 when the circuit housing 332 is mounted to the exterior side of the canister cover 322.

When the circuitry housing 332 is installed on the canister cover 322, the first and second terminal posts 358a, 358b extend through the circuitry housing 332 and circuitry housing fasteners 380 are secured to the first and second terminal posts 358a, 358b to secure the circuitry housing 332 to the canister cover 322. A threaded engagement can be provided between the first and second terminal posts 358a, 358b and the circuitry housing fasteners 380. For example, as depicted, the circuitry housing fasteners 380 are depicted as nuts having internal threads 381 and external wrench flats. The internal threads 381 are adapted to engage the external threads 368 of the first and second terminal posts 358a, 358b. By threading the circuitry housing fasteners 380 on the first and second terminal posts 358a, 358b to a sufficient tightness (e.g., to a sufficient torque level), the circuitry housing 332 can be secured on the first and second terminal posts 358a, 358b by being clamped between the circuitry housing fasteners 380 and the canister cover 322.

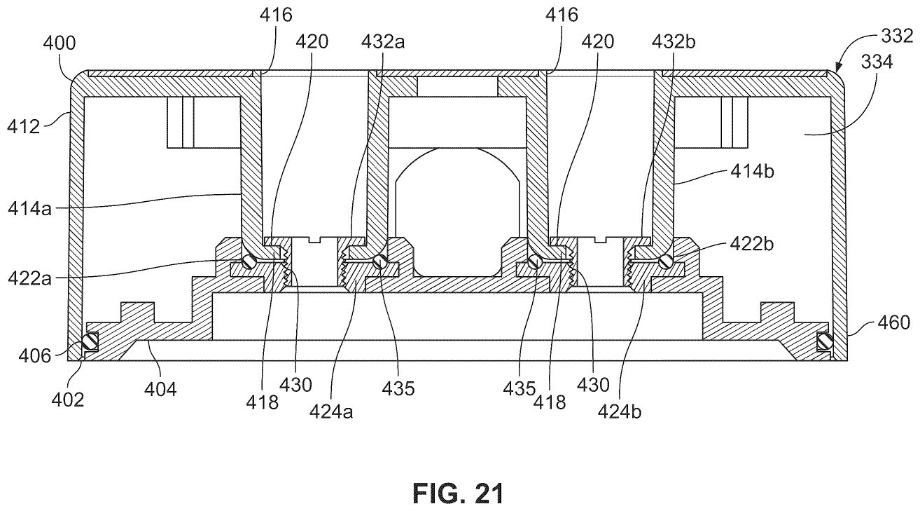

Referring to FIGS. 20 and 21, the circuitry housing 332 has an upper dome 400 having an open bottom 402. The circuitry housing 332 also includes a lower base 404 that mounts to the upper dome 400 to cover the open bottom 402. In one example, the upper dome 400 is detachable from the lower base 404. In one example, the upper dome 400 and the lower base 404 are environmentally sealed with respect to each other when secured together. In one example, the environmental seal is a water-tight seal. For example, as depicted at FIG. 21, the lower base 404 fits inside a lower portion of the upper dome 400 and a seal 406 (e.g., an elastomeric sealing member which may include a gasket member such as an o-ring) provides sealing (e.g., radial sealing) between the upper dome 400 and the lower base 404. The upper dome 400 and the lower base 404 can each have polymeric construction (e.g., a molded, plastic construction).

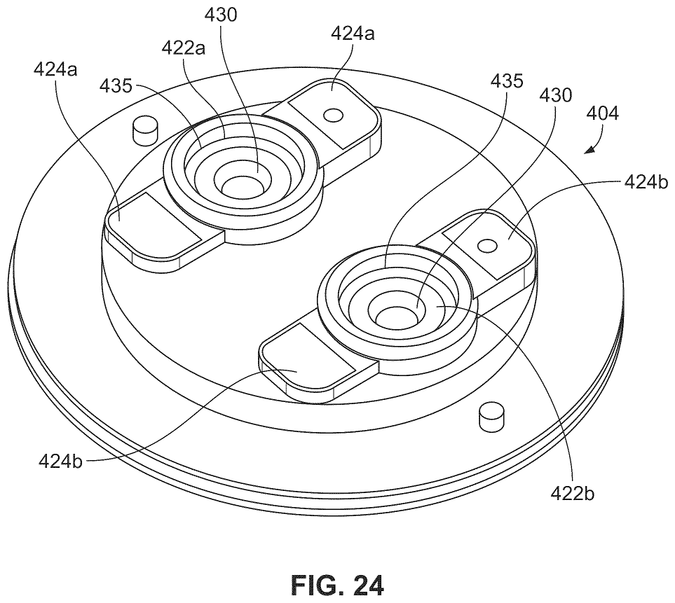

The upper dome 400 includes a main dome body 412 and first and second sleeves 414a, 414b that project downwardly from the main dome body 412. The first and second sleeves 414a, 414b include open upper ends 416 and lower ends 418. The lower ends 418 of the first and second sleeves 414a, 414b define sleeve shoulders 420. As shown at FIG. 20, the first and second terminal posts 358a, 358b extend through the lower base 404 and respectively into (e.g., at least partially through) the first and second sleeves 414a, 414b. The circuitry housing fasteners 380 fit within the first and second sleeves 414a, 414b and are accessible through the first and second sleeves 414a, 414b from the open upper ends 416 of the first and second sleeves 414a, 414b. The lower ends 418 of the first and second sleeves 414a, 414b respectively fit within first and second pockets 422a, 422b (see FIGS. 21 and 24) defined by the lower base 404.

The circuit arrangement 338 of the biocide-generating device 321 includes first and second termination plates 424a, 424b (see FIG. 24) that are at least partially embedded in the polymeric material of the lower base 404. The first and second termination plates 424a, 424b are preferably adapted to resist corrosion and to conduct both electricity and heat. In certain examples the first and second termination plates 424a, 424b are made of a material having a composition that includes metal (e.g., a metal element such as titanium or a metal alloy material such as stainless steel). The first and second termination plates 424a, 424b define threaded base retention openings 430 located at bottom regions of the first and second pockets 422a, 422b. The biocide-generating device 321 includes base retention fasteners 432a, 432b that seat on the sleeve shoulders 420 within the first and second sleeves 414a, 414b and thread within the base retention openings 430 to secure the lower base 404 to the upper dome 400. As shown at FIG. 20, the first and second terminal posts 358a, 358b respectively extend through the base retention fasteners 432a, 432b and the circuitry housing fasteners 380 seat on the base retention fasteners 432a, 432b. The first and second terminal posts 358a, 358b are respectively electrically connected to the first and second termination plates 424a, 424b by the circuitry housing fasteners 380 and the base retention fasteners 432a, 432b. Electric leads within the circuitry housing 332 can electrically connect the first power conversion circuit 348 on the circuit board 355 to the first and second termination plates 424a, 424b. The biocide-generating device further includes elastomeric seals 435 that are co-axial with respect to respective ones of the termination posts 358a, 358b, and that fit within the first and second pockets 422a, 422b and seal between the lower ends 418 of the first and second sleeves 414a, 414b and the lower base 404 (e.g., against the termination plates 424a, 424b of the lower base 414).

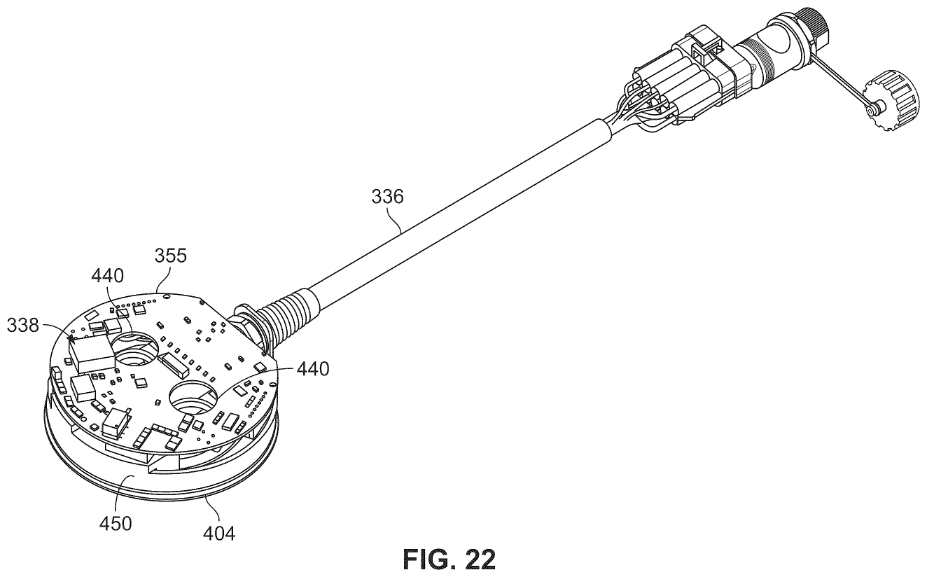

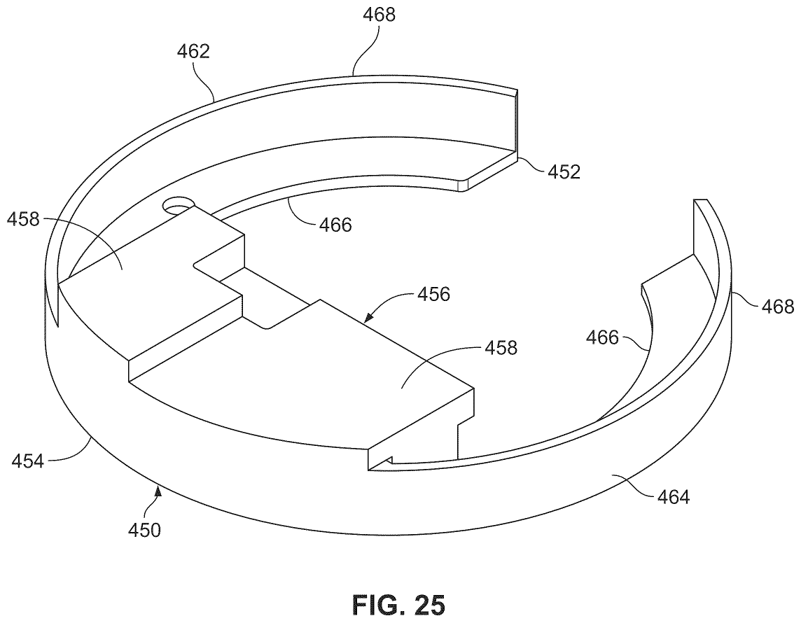

The circuit board 355 housed within the circuitry housing 332 defines openings 440 (see FIG. 22) through which the first and second sleeves 414a, 414b extend. The biocide-generating device 321 also includes a heat sink 450 positioned within the circuitry housing 332 beneath the circuit board 354 for transferring heat from one or more heat generating components (e.g., the first and second power conversion circuits 348, 350) on the circuit board 354 to at least one of the first and second termination plates 424a, 424b. The first and second termination plates 424a, 424b are configured to transfer heat respectively to the first and second terminal posts 358a, 358b. The heat sink 450 can be constructed of a material having a composition that includes metal (e.g., a metal element, a metal alloy, metal compound) adapted for transferring heat. The heat sink 450 includes an open end 452 and a closed end 454. In one example, the heat sink 450 is C-shaped or horseshoe shaped (see FIG. 25). The power cable 336 passes through the open end 452 of the heat sink 450 when the power cable 336 enters the circuitry housing 332. In this way, the presence of the heat sink 450 does not interfere with routing of the power cable 336 into the circuitry housing 332. The heat sink 450 includes an enlarged heat sink mass 456 at the closed end 454 defining one or more upper heat sink surfaces 458 that oppose the one or more heat generating components (e.g., the first and second power conversion circuits 348, 350) and one or more lower heat sink surfaces 459 that oppose the first and second termination plates 424a, 424b. The enlarged heat sink mass 456 is configured to transfer heat by conduction from the heat generating components to the first and second termination plates 424a, 424b, which in turn transfer the heat to the electrode arrangement 330 through the first and second termination posts 358a, 358b (e.g., the heat is conveyed through the first and second termination posts 358a, 358b to the electrode plates 356a, 356b where the heat is transferred to the water flowing through the biocide-generating device 321). In certain examples, heat conductive pads can be provided between the plates 424a, 424b and the lower heat sink surface 459.

The upper dome 400 includes a side wall 460 defining a circular shape. The heat sink 450 has an outer circular shape that extends along and opposes an inner surface of the side wall 460 of the upper dome 400. The heat sink 450 includes first and second legs 462, 464 that extend from the enlarged heat sink mass 456 at the closed end 454 of the heat sink 450 to the open end 452 of the heat sink 450. Each of the first and second legs 462, 464 has a L-shaped cross-section formed by a leg bottom wall 466 that opposes the lower base 404 of the circuitry housing and a leg side wall 468 that opposes the inner surface of the side wall 460 of the upper dome 400 of the circuitry housing 332. The first and second legs 462, 464 are configured for transferring heat from within the circuitry housing 332 outwardly through the side wall 460 (e.g., via the leg side walls 468) and outwardly through the lower base 404 (e.g., via the leg bottom walls 466).

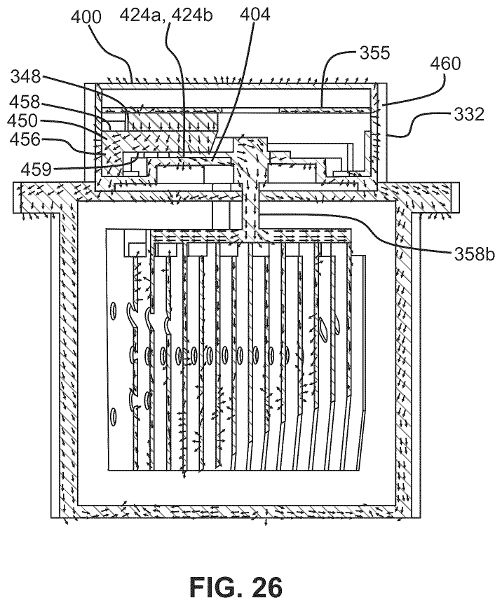

FIG. 26 provides heat flow arrows depicting heat flow within the circuitry housing 322. As depicted, the enlarged heat sink mass 456 conveys heat from heat generating components on the bottom of the circuit board 355 to the first and second termination plates 424a, 424b. From the first and second termination plates 424a, 424b, the heat is transferred to the water flowing through the biocide-generating device by the electrode arrangement 330. The circuitry housing fasteners 380 and the base retention fasteners 432a, 432b aide in the transfer of heat from the termination plates 424a, 424b to the electrode arrangement 330. The first and second legs 462, 464 of the heat sink 450 assist in the transfer of heat through peripheral walls (e.g., the side wall and bottom wall) of the circuitry housing 322.

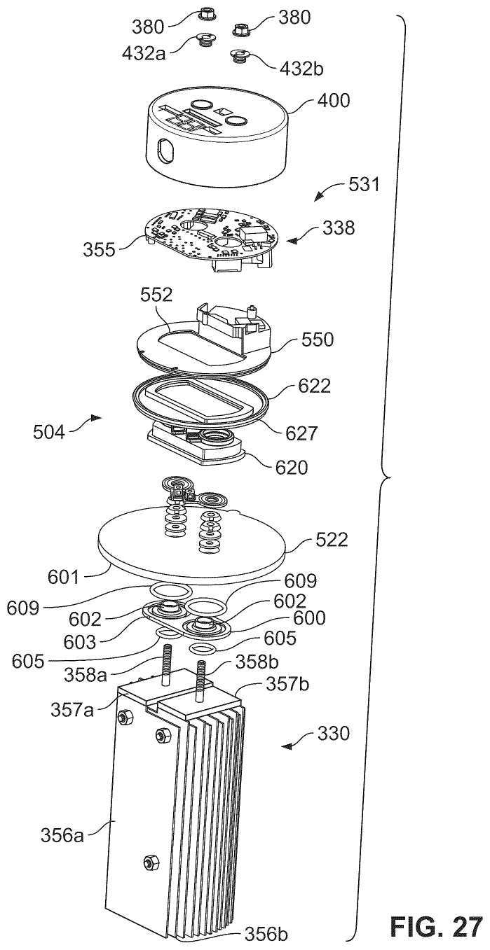

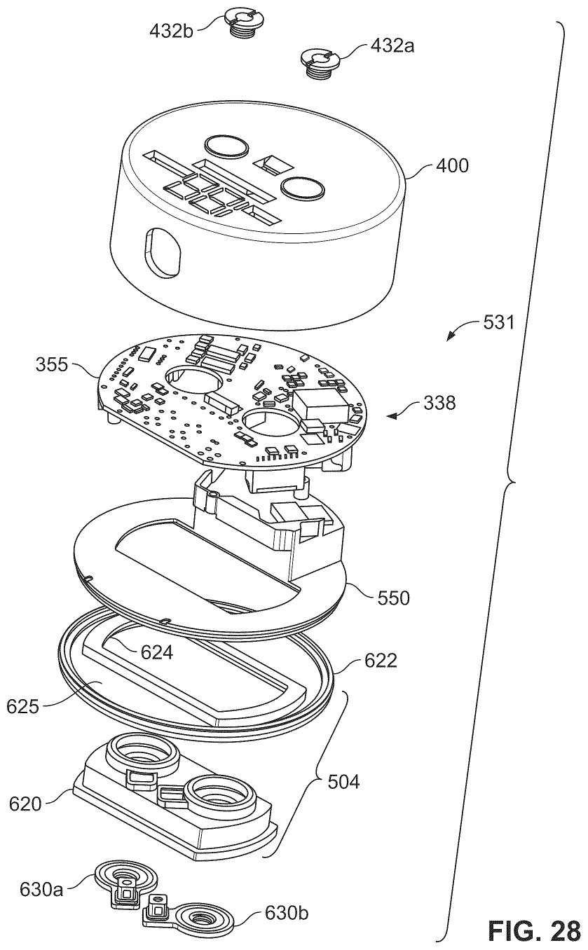

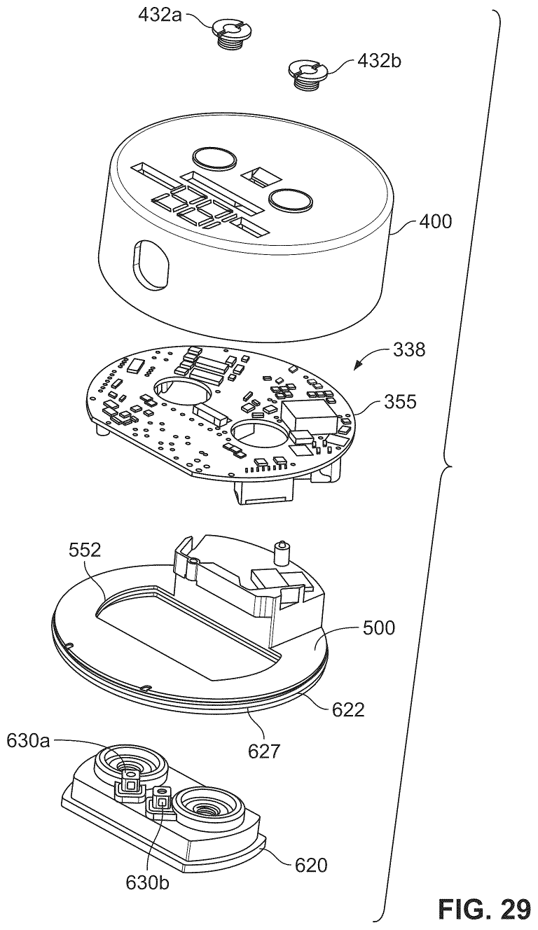

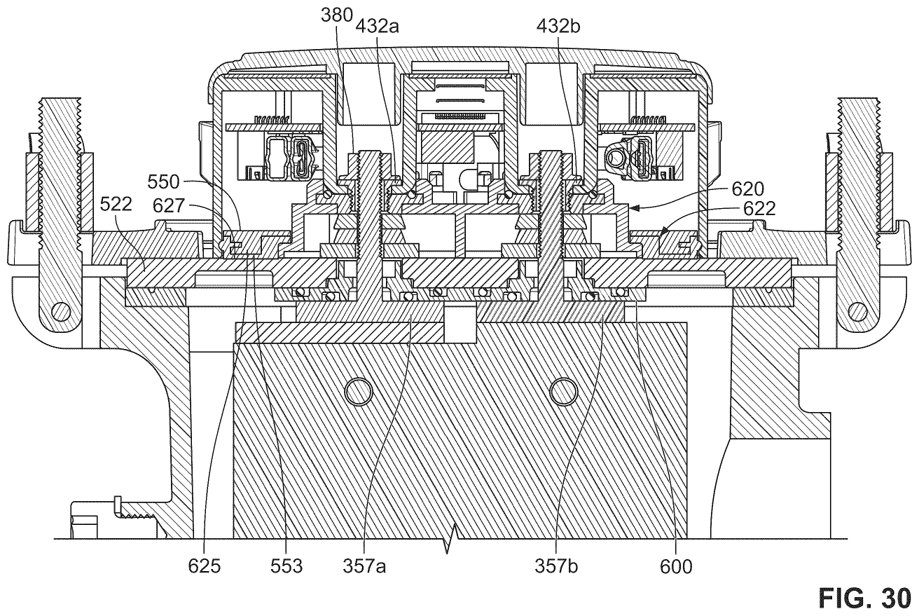

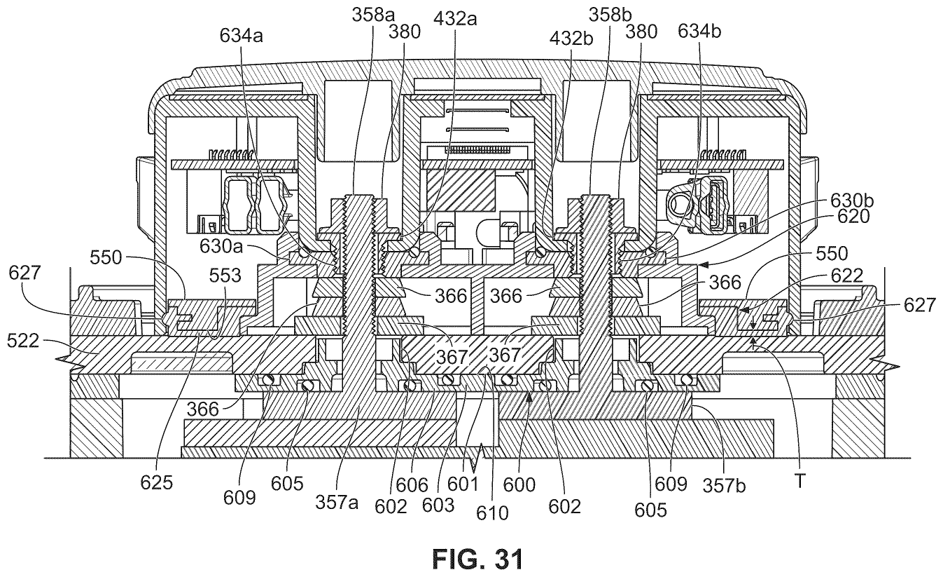

FIGS. 27-30 depict another control assembly 531 in accordance with the principles of the present disclosure that is adapted for controlling operation of the electrode arrangement 330 (including terminal posts 358a, 358b respectively connected to electrode plates 356a, 356b by plate connection members 357a, 357b). The control assembly 531 has the same configuration as the control assembly 331 (e.g., including circuit arrangement 338, upper dome 400, circuitry housing fasteners 380, and base retention fasteners 432a, 432b), except has been modified for use with a heat conductive canister cover 522 to enhance the transfer of heat from the control assembly 531 through the canister cover 522 to the canister body 160 and/or to water flowing through the electrolytic cell (i.e., through the canister body 160). For example, the control assembly 531 includes a modified heat sink 550 and modified lower base 504 which have been designed to enhance the transfer of heat from within circuitry housing 532 through the canister cover 522 to the canister body 160 and/or to water flowing through canister body 160 of the electrolytic cell. The heat sink 550 is constructed of a heat conductive material (e.g., metal) and is positioned beneath circuit board 355 and is configured for transferring heat from one or more heat generating components on the circuit board 355 though the lower base 504 of the circuitry housing 532 into the canister cover 522 when the circuitry housing 532 is installed on the canister cover 522. The canister cover 522 is configured to transfer heat respectively to other parts of the canister and/or water flowing through the canister and preferably has a construction adapted for transferring heat such as a metal construction (e.g., stainless steel, titanium, etc.) or a plastic construction including plastic impregnated with hear transfer additives.

In certain examples, at least a portion of the lower base 504 has a thickness of less than 1.5 mm thick between the heat sink 550 and the canister cover 522 to increase heat transfer. In certain examples, the lower base 504 includes a lower base material that is an elastomer that compresses during installation of the circuitry housing 532 on the canister cover 522 to reduce air gaps created by surface imperfections of opposing surfaces of the lower base 504 and the canister cover 522 to increase heat transfer. In certain examples, the elastomer defines at least 30, 40 or 50 percent of a bottom surface area of the lower base 504. In certain examples, the heat sink 550 has a bottom surface area that contacts the elastomeric lower base material with the bottom surface area of the heat sink 550 that contacts the elastomeric lower base material being at least 20, 25, 30, 40, or 50 percent as large as an area defined by a perimeter of the bottom of the lower base 504. In one example, the elastomeric lower base material includes silicone or is silicone based.

In certain examples, the electrode arrangement 330 mounts to the canister cover 522 and the biocide-generating device includes a dielectric insulator plate 600 positioned between a bottom side 601 of the canister cover 522 and the pluralities of first and second electrode plates 356a, 356b. The dielectric insulator plate 600 includes insulating sleeves 602 that project upwardly from a main body 603 of the dielectric insulator plate 600 into openings of the canister cover 522 through which the first and second terminal posts 358a, 358b extend. The first and second terminal posts 358a, 358b extend through the insulating sleeves 602 and the insulating sleeves 602 electrically isolate the first and second terminal posts 358a, 358b from the canister cover 522. The canister cover 522 can have a metal construction. First elastomeric seals 605 can be provided around each of the first and second terminal posts 358a, 358b for sealing between a bottom side 606 of the main body 603 of the dielectric insulator plate 600 and the plate connection members 357a, 357b providing electrical connection between the first and second terminal posts 358a, 358b and the pluralities of first and second electrode plates 356a, 356b. Second elastomeric seals 609 can be provided around each of the first and second terminal posts 358a, 358b for sealing between a top side 610 of the main body 603 of the dielectric insulator plate 600 and the bottom side 601 of the canister cover 522.

In certain examples, the lower base 504 has a composite construction including an inner portion 620 constructed of a first polymeric material and an outer portion 622 surrounding the inner portion 620 constructed of a second polymeric material. Preferably, the second polymeric material is softer than the first polymeric material (i.e., the outer portion 622 has a softer construction than the inner portion 620). In certain examples, the inner and outer portions 620, 622 are co-molded with respect to each other. In certain examples, the first polymeric material is a thermoplastic material and the second polymeric material includes siloxane. In certain examples, the first polymeric material is plastic and the second polymeric material is an elastomer.

As shown at FIGS. 27-30, the outer portion 622 defines a central opening 624 in which the inner portion 620 is positioned. As depicted for illustration purposes, the inner and outer portions 620, 622 are shown separate, but in preferred practice the inner and outer portions 620, 622 would be co-molded together as one component. The outer portion 622 extends radially outwardly from the inner portion 620. The heat sink 550 defines an heat sink opening 552 in which the inner portion 620 is positioned. The heat sink 550 includes a bottom surface 553 which is opposed by a bottom wall portion 625 of the outer portion 622. The outer portion 622 also includes a unitary seal portion 627 that circumferentially surrounds the outer portion 622, that wraps around a perimeter of the heat sink 550 and that seals the lower base 504 with respect to the upper dome 400 of the circuitry housing 532. The bottom wall portion 625 and the seal portion 627 of the outer portion 622 are formed as a single unitary piece. As depicted the seal portion 627 forms a radial seal with respect to the interior of the upper dome 400 when the circuitry housing 532 is assembled.

In certain examples, the bottom wall portion 625 has a thickness T of less than 1.5 mm thick between the bottom surface of the heat sink 550 and the top surface of the canister cover 522 to increase heat transfer. In certain examples, at least 20 percent, or at least 30 percent, or at least 40 percent of the bottom surface of the heat sink is opposed by and contacts the thin bottom wall. In the example of FIGS. 27-30, the bottom wall portion 625 is an elastomer that compresses during installation of the canister cover 522 to reduce air gaps created by surface imperfections of the opposing surfaces of the bottom wall portion 625 and the canister cover 522 to increase heat transfer.

Similar to previously described examples, the electrode arrangement 330 mounts to the canister cover 522. For example, the first and second terminal posts 358a, 358b extend through the canister cover 522 and electrode fasteners 366 are secured to the first and second terminal posts 358a, 358b to mount the electrode arrangement 330 to the canister cover 522. Dielectric spacers 367 (e.g., dielectric washers) mount on the terminal posts 358a, 358b between the electrode fasteners 366 and the canister cover 522 to electrically isolate the electrode fasteners 366 from the canister cover 522. The first and second terminal posts 358a, 358b extend through the inner portion 620 of the lower base 504 when the circuitry housing 532 is installed on the canister cover 522. Circuitry housing fasteners 380 are secured to the first and second terminal posts 358a, 358b to secure the circuitry housing 532 to the canister cover 522.

In the depicted example, first and second termination plates 630a, 630b are at least partially embedded in the inner portion 620 of the lower base 504. The first and second termination plates 630a, 630b define threaded base retention openings 634a, 634b and base retention fasteners 432a, 432b thread within the threaded base retention openings 634a, 634b to secure the lower base 504 to the upper dome 400 of the circuitry housing 532. The first and second terminal posts 358a, 358b extend through the base retention fasteners 432a, 432b. The circuitry housing fasteners 380 seat on the base retention fasteners 432a, 432b. The first and second terminal posts 358a, 358b are respectively electrically connected to the first and second termination plates 630a, 630b by the circuitry housing fasteners 380 and the base retention fasteners 432a, 432b. Electric leads within the circuitry housing 532 can electrically connect the power conversion circuit to the first and second termination plates 630a, 630b.

In certain examples, canister covers in accordance with the present disclosure can have plastic constructions or metal constructions (e.g., stainless steel constructions, titanium constructions, etc.). The plastic constructions can include constructions with or without heat transfer additives. The plastic constructions can include materials such as thermoplastic material.

As depicted, in some embodiments, the sets of electrode members of biocide-generating devices disclosed herein can be in the form of electrode plates (e.g., anode plates and cathode plates that are interleaved with respect to each other), which can be in electrical communication with electrical circuitry configured to apply an electrical current across the electrodes for driving an electrolysis reaction resulting in the generation of a biocide (e.g., chlorine, copper, etc. and derivatives thereof). In some examples, at least one of the electrode arrangements comprise one or more of copper, aluminum, zinc, silver or another electrical conductor, such as carbon or conductive polymer, mixed with an inhibiting material having biological inhibiting properties. In some embodiments, the sets of electrodes can be coated with a catalyst material (e.g., oxides of iridium, ruthenium, titanium, tantalum, niobium, etc.) for catalyzing the production of chlorine or derivatives thereof.

For saltwater applications, a preferred biocide generated by the biocide-generating devices of the type disclosed herein includes chlorine and/or derivatives thereof. Other biocides can be generated dependent upon the type of salts or ions present in the water. The process for generating biocide can include an in situ process where ionized water (e.g., seawater, ocean water, brackish water, salt-pool water, etc.) is subjected to electrolysis as the water flows through the biocide-generating devices. The first and second electrodes can respectively define an anode (e.g., a positive pole) and a cathode (e.g., a negative pole) with the direct passage of electrical current through the water between the anode and the cathode driving the electrolysis. The polarity of the electrodes can be periodically shifted to reduced sealing on the electrodes.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

1. A biocide-generating device, comprising:
a main housing defining a chamber, the main housing including a canister body having an open end and a closed end, the canister body having inlet and outlet ports in fluid communication with the chamber, wherein the main housing also includes a canister cover adapted to be removably secured to the open end of the canister body to close the open end of the canister body;
an electrode arrangement including first and second electrodes positioned within the chamber for generating biocide within the chamber; and
a control assembly including:
a circuitry housing that removably mounts at a top of the canister cover, the circuitry housing being installable on and removable from the canister cover while an interior of the circuitry housing remains enclosed;
a power cord that extends into the circuitry housing for providing electric power to the electrode arrangement; and
a circuit arrangement housed within the circuitry housing, the circuit arrangement including a power conversion circuit for providing power conversion to the electric power provided to the electrode arrangement from the power cord, the circuit arrangement also including switching circuitry for switching a polarity of the first and second electrodes.

2. The biocide-generating device of claim 1, wherein the circuit arrangement includes an electronic controller, wherein the power conversion circuit is a first power conversion circuit for reducing a voltage of the electric power provided to the electrode arrangement from the power cord, and wherein the circuit arrangement includes a second power conversion circuit for providing power conversion to electric power provided to the electronic controller from the power cord.

3. The biocide-generating device of claim 2, wherein the circuit arrangement includes a constant current source for driving an electrical current between the first and second electrodes, wherein the electronic controller interfaces with a flow sensor for sensing water flow through the biocide-generating device and varies a magnitude of the constant current based on sensed flow, and wherein the circuit arrangement is supported by a circuit board housed within the circuitry housing.

4. The biocide-generating device of claim 1, wherein the electrode arrangement mounts to the canister cover, wherein the first electrode includes a plurality of first electrode plates electrically coupled to a first terminal post, wherein the second electrode includes a plurality of second electrode plates electrically coupled to a second terminal post, wherein the first and second terminal posts extend through the canister cover and electrode fasteners are secured to the first and second terminal posts to mount the electrode arrangement to the canister cover, wherein the first and second terminal posts extend through the circuitry housing when the circuitry housing is installed on the canister cover, and wherein circuitry housing fasteners are secured to the first and second terminal posts to secure the circuitry housing to the canister cover.

5. The biocide-generating device of claim 4, wherein the first and second terminal posts have external threads and the electrode and circuitry housing fasteners have internal threads that engage the external threads of the first and second terminal posts.

6. The biocide-generating device of claim 5, wherein the circuitry housing has an upper dome having an open bottom and a lower base that mounts to the upper dome to cover the open bottom, wherein the upper dome includes a main dome body and first and second sleeves that project downwardly from the main dome body, the first and second sleeves including open upper ends and lower ends, the lower ends of the first and second sleeves defining sleeve shoulders, wherein the first and second terminal posts extend through the lower base and respectively through the first and second sleeves, wherein the circuitry housing fasteners fit within the first and second sleeves and are accessible through the first and second sleeves from the open upper ends of the first and second sleeves, and wherein lower ends of the first and second sleeves respectively fit within first and second pockets defined by the lower base.

7. The biocide-generating device of claim 6, wherein first and second termination plates are at least partially embedded in the lower base, wherein the first and second termination plates define threaded base retention openings, wherein the biocide-generating device includes base retention fasteners that seat on the sleeve shoulders within the first and second sleeves and thread within the base retention openings to secure the lower base to the upper dome, wherein the first and second terminal posts extend through the base retention fasteners, wherein the circuitry housing fasteners seat on the base retention fasteners, wherein the first and second terminal posts are respectively electrically connected to the first and second termination plates by the circuitry housing fasteners and the base retention fasteners, and wherein electric leads within the circuitry housing electrically connect the power conversion circuit to the first and second termination plates.

8. The biocide-generating device of claim 7, further comprising a first seal between the upper dome and the lower base, and second seals that fit within the first and second pockets and seal between the lower ends of the first and second sleeves and the lower base.

9. The biocide-generating device of claim 7, further comprising a circuit board within the circuitry housing for supporting the circuit arrangement, the circuit board defining openings through which the first and second sleeves extend, the biocide-generating device also including a heat sink positioned within the circuitry housing beneath the circuit board for transferring heat from one or more heat generating components on the circuit board to at least one of the first and second termination plates, and wherein the first and second termination plates are configured to transfer heat respectively to the first and second terminal posts.

10. The biocide-generating device of claim 9, wherein the one or more heat generating components includes the power coversion circuit.

11. The biocide-generating device of claim 9, wherein the heat sink includes an open end and a closed end, wherein the power cable passes into the circuitry housing through the open end.

12. The biocide-generating device of claim 11, wherein the heat sink includes an enlarged heat sink mass at the closed end defining one or more upper heat sink surfaces that oppose the one or more heat generating components and one or more lower heat sink surfaces that oppose the first and second termination plates.

13. The biocide-generating device of claim 12, wherein the upper dome includes a side wall defining a circular shape, and wherein the heat sink has an outer circular shape that extends along and opposes an inner surface of the side wall of the upper dome.

14. The biocide-generating device of claim 13, wherein the heat sink includes first and second legs that extend from the enlarged heat sink mass at the closed end of the heat sink to the open end of the heat sink, wherein each of the first and second legs has a L-shaped cross-section formed by a leg bottom wall that opposes the lower base of the circuitry housing and a leg side wall that opposes the inner surface of the side wall of the upper dome of the circuitry housing.

15. The biocide-generating device of claim 1, further comprising a circuit board within the circuitry housing for supporting the circuit arrangement, the biocide-generating device also including a heat sink positioned within the circuitry housing beneath the circuit board for transferring heat from one or more heat generating components on the circuit board to a side or bottom wall of the circuitry housing and/or to electrode arrangement, wherein the heat sink includes an open end and a closed end, wherein the power cable passes into the circuitry housing through the open end.

16. The biocide-generating device of claim 15, wherein the one or more heat generating components includes the power coversion circuit.

17. The biocide-generating device of claim 15, wherein the heat sink includes an enlarged heat sink mass at the closed end defining one or more upper heat sink surfaces that oppose the one or more heat generating components.

18. The biocide-generating device of claim 17, wherein the circuitry housing includes a side wall defining a circular shape, and wherein the heat sink has an outer circular shape that extends along and opposes an inner surface of the side wall of the upper dome.

19. The biocide-generating device of claim 18, wherein the heat sink includes first and second legs that extend from the enlarged heat sink mass at the closed end of the heat sink to the open end of the heat sink, wherein each of the first and second legs has a L-shaped cross-section formed by a leg bottom wall that opposes a lower base of the circuitry housing and a leg side wall that opposes the inner surface of the side wall of the circuitry housing.

20. The biocide-generating device of claim 1, further comprising a circuit board within the circuitry housing for supporting the circuit arrangement, the control assembly also including a heat sink positioned within the circuitry housing beneath the circuit board for transferring heat from one or more heat generating components on the circuit board though a lower base of the circuitry housing into the canister cover when the circuitry housing is installed on the canister cover, and wherein the canister cover is configured to transfer heat respectively to other parts of the canister and/or water flowing through the canister.

21. The biocide-generating device of claim 20, wherein at least a portion of the lower base has a thickness of less than 1.5 mm thick between the heat sink and the canister cover to increase heat transfer.

22. The biocide-generating device of claim 20, wherein the lower base includes a lower base material that is an elastomer that compresses during installation of the circuitry housing on the canister cover to reduce air gaps created by surface imperfections of opposing surfaces of the lower base and the canister cover to increase heat transfer.

23. The biocide-generating device of claim 22, wherein the lower base material includes silicone or is silicone based.

24. The biocide-generating device of claim 20, wherein the canister cover has a construction including plastic impregnated with hear transfer additives.

25. The biocide-generating device of claim 20, wherein the canister cover has a metal construction, wherein the electrode arrangement includes conductive electrode posts that extend through openings in the canister cover, and wherein electrical insulator sleeves are provided around the conductive electrode posts within the openings in the canister cover to electrically isolate the conductive electrode posts from the canister cover.

26. The biocide-generating device of claim 25, wherein the metal construction of the canister cover includes titanium or stainless steel.

27. The biocide-generating device of claim 20, wherein the electrode arrangement mounts to the canister cover, wherein the first electrode includes a plurality of first electrode plates electrically coupled to a first terminal post, wherein the second electrode includes a plurality of second electrode plates electrically coupled to a second terminal post, wherein the first and second terminal posts extend through the canister cover and electrode fasteners are secured to the first and second terminal posts to mount the electrode arrangement to the canister cover, wherein the first and second terminal posts extend through the circuitry housing when the circuitry housing is installed on the canister cover, and wherein circuitry housing fasteners are secured to the first and second terminal posts to secure the circuitry housing to the canister cover, wherein the canister cover has a metal construction, wherein the biocide-generating device includes a dielectric insulator plate positioned between a bottom side of the canister cover and the pluralities of first and second electrode plates, wherein the dielectric insulator plate includes insulating sleeves that project upwardly from a main body of the dielectric insulator plate into openings of the canister cover through which the first and second terminal posts extend, wherein the first and second terminal posts extend through the insulating sleeves and the insulating sleeves electrically isolate the first and second terminal posts from the canister cover.

28. The biocide-generating device of claim 27, further comprising first elastomeric seals around each of the first and second terminal posts for sealing between a bottom side of the main body of the dielectric insulator plate and plate connection members providing electrical connection between the first and second terminal posts and the pluralities of first and second electrode plates, and second elastomeric seals around each of the first and second terminal posts for sealing between a top side of the main body of the dielectric insulator plate and the bottom side of the canister cover.

29. The biocide-generating device of claim 20, wherein the lower base has a composite construction including an inner portion constructed of a first polymeric material and an outer portion surrounding the inner portion constructed of a second polymeric material, wherein the second polymeric material is softer than the first polymeric material.

30. The biocide-generating device of claim 29, wherein the inner and outer portions are co-molded.

31. The biocide-generating device of claim 29, wherein the first polymeric material is a thermoplastic material and the second polymeric material includes siloxane.

32. The biocide-generating device of claim 29, wherein the first polymeric material is plastic and the second polymeric material is an elastomer.

33. The biocide-generating device of claim 29, wherein the outer portion defines a central opening in which the inner portion is positioned, wherein the outer portion extends radially outwardly from the inner portion, wherein the heat sink defines an heat sink opening in which the inner portion is positioned, wherein the heat sink includes a bottom surface which is opposed and contacted by a bottom wall portion of the outer portion, wherein the outer portion also includes a unitary seal portion that circumferentially surrounds the outer portion, that wraps around a perimeter of the heat sink and that seals the lower base with respect to a top cover of the circuitry housing.

34. The biocide-generating device of claim 33, wherein the bottom wall portion has a thickness of less than 1.5 mm thick between the heat sink and the canister cover to increase heat transfer, and wherein the bottom wall portion is an elastomer that compresses during installation of the canister cover to reduce air gaps created by surface imperfections of opposing surfaces of the bottom wall portion and the canister cover to increase heat transfer.

35. The biocide-generating device of claim 34, wherein the electrode arrangement mounts to the canister cover, wherein the first electrode includes a plurality of first electrode plates electrically coupled to a first terminal post, wherein the second electrode includes a plurality of second electrode plates electrically coupled to a second terminal post, wherein the first and second terminal posts extend through the canister cover and electrode fasteners are secured to the first and second terminal posts to mount the electrode arrangement to the canister cover, wherein the first and second terminal posts extend through the inner portion of the lower base when the circuitry housing is installed on the canister cover, and wherein circuitry housing fasteners are secured to the first and second terminal posts to secure the circuitry housing to the canister cover.

36. The biocide-generating device of claim 35, wherein first and second termination plates are at least partially embedded in the inner portion of the lower base, wherein the first and second termination plates define threaded base retention openings, wherein the biocide-generating device includes base retention fasteners that thread within the threaded base retention openings to secure the lower base to the top cover of the circuitry housing, wherein the first and second terminal posts extend through the base retention fasteners, wherein the circuitry housing fasteners seat on the base retention fasteners, wherein the first and second terminal posts are respectively electrically connected to the first and second termination plates by the circuitry housing fasteners and the base retention fasteners, and wherein electric leads within the circuitry housing electrically connect the power conversion circuit to the first and second termination plates.

37-66. (canceled)
